(19) United States
(12) Patent Application Publication
(10) Pub. No.: US 2016/0150809 A1
(43) Pub. Date: Jun. 2, 2016

(54) ALGAL-BASED ANIMAL FEED COMPOSITION CONTAINING EXOGENOUS PROTEASE ANIMAL FEED SUPPLEMENT, AND USES THEREOF

(71) Applicant: CORNELL UNIVERSITY, Ithaca, NY (US)

(72) Inventor: Xingen LEI, Ithaca, NY (US)

(21) Appl. No.: 14/904,295

(22) PCT Filed: Jul. 10, 2014
(86) PCT No.: PCT/US14/46121

§ 371 Date: Jan. 11, 2016

Related U.S. Application Data
(60) Provisional application No. 61/845,243, filed on Jul. 11, 2013.

(51) Int. Cl. A23K 1/14

(52) U.S. Cl. CPC A23K 1/1656; A23K 1/1631; A23K 1/17; A23K 1/1603; A23K 1/1758

(57) ABSTRACT

The present invention relates to an animal feed composition comprising one or more grains in an amount totaling 48-70% w/w of the composition; a non-algal protein source in an amount totaling 15-30% w/w of the composition; algae in an amount totaling 3-15% w/w of the composition; an exogenous protease totaling 0.01-0.1% w/w of the composition; and an oil heterologous to the algae in an amount totaling 0.5-15% w/w of the composition. The present invention also relates to an animal feed supplement, methods of feeding an animal, methods of improving the feed efficiency of an animal, and an improvement to an animal feed.

This application claims the benefit of U.S. Provisional Patent Application Ser. No. 61/845,243, filed Jul. 11, 2013, which is hereby incorporated by reference in its entirety.

### FIELD OF THE INVENTION

The present invention relates to algal-based animal feed compositions, animal feed supplements, and uses thereof.

### BACKGROUND OF THE INVENTION

Corn and soybean acreage account for 29 and 26% of national crop land, respectively (Cromwell, “Soybean Meal—The “Gold Standard,” The Farmer's Pride, KPPA News, Vol. 11, No. 20, Nov. 10, 1999). Approximately 60% of corn and 47% of soy produced in the United States is used by the feed industry, mainly to raise chickens and pigs (Olson, “Below Cost Feed Crops: An Indirect Subsidy for Industrial Animal Factories,” Issues 202:222 (2011)). While they represent the two major meat-producing species, their massive consumption of corn and soy directly competes with the human food supply. Thus, alternative feed ingredients are needed to sustain animal agriculture and human food security. Various marine microalgae have been tested in diets for poultry (Grau et al., “Sewage-Grown Algae as a Feedstuff for Chicks,” Poult. Sci. 36:1046-1051 (1957); Mokady et al., “Algae Grown on Wastewater as a Source of Protein for Young Chickens and Rats,” Nutr. Rep. Int. 9:383-390 (1979); Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013)) and swine (Hintz et al., “Sewage-Grown Algae as a Protein Supplement for Swine,” Anim. Prod. 9:135-140 (1967); Yap et al., “Feasibility of Feeding Spirulina-Maxima, Arthrospira-Platensis or Chlorella Sp to Pigs Weaned to a Dry Diet at 4 to 8 Days of Age,” Nutr. Rep. Int. 25:543-552 (1982); Isaacs et al., “A Partial Replacement of Soybean Meal by whole or Defatted Algal Meal in Diet for Weanling Pigs Does not Affect their Plasma Biochemical Indicators,” J. of Animal Sci. 89:723-723 (2011)). Along with recent interests in using microalgae as feedstock for the third generation of biofuel production (Chisti, “Biodiesel from Microalgae,” Biotechnol. Adv. 25:294-306 (2007)), efficacy of inclusions of defatted diatom microalgae Staurospira sp. into diets for broiler chicks (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013)) and weanling pigs (Isaacs et al., “A Partial Replacement of Soybean Meal by whole or Defatted Algal Meal in Diet for Weanling Pigs Does not Affect their Plasma Biochemical Indicators,” J. of Animal Sci. 89:723-723 (2011)) has been determined.

In three consecutive chick experiments, it was demonstrated that the inclusion of 7.5% defatted diatom microalgae in the diets for broiler chicks to replace corn and soybean meal did not impair their growth performance or biochemical status during the full production cycle (day 1 to 42) (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013)). However, including defatted diatom microalgae at 10% replacing corn and soybean meal or 7.5% replacing soybean meal alone resulted in negative impacts on the growth performance of chicks. Because defatted diatom microalgae contained a lower level of crude protein than soybean meal (19.1 vs. 48.5%), the practical question was if the broiler chicks could tolerate higher inclusions of other types of defatted microalgal biomass that have better profiles of protein, amino acids, and other components. While supplementing defatted diatom microalgae up to 10% in the diets showed little effect on a number of plasma biochemical indicators of chicks, the effects on plasma uric acid, the end product and sensible biomarker of avian nitrogen metabolism (Donsbough et al., “Uric Acid, Urea, and Ammonia Concentrations in Serum and Uric Acid Concentration in Excreta as Indicators of Amino Acid Utilization in Diets for Broilers,” Poult. Sci. 89:287-294 (2010); Hernandez et al., “Effect of Low-Protein Diets and Single Sex on Production Performance, Plasma Metabolites, Digestibility, and Nitrogen Excretion in 1- to 48-Day-Old Broilers,” Poult. Sci. 91:683-692 (2012)), remained inconclusive (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013); Leng et al., “Effect of Dietary Defatted Diatom Biomass on Egg Production and Quality of Laying Hens,” J. Anim. Sci. Biotechnol. 5:3 (2014)). Effects of the supplemental defatted diatom microalgae on plasma amino acid profile were not determined. In addition, a previous study tested effects of only a supplemental commercial protease in the 7.5% defatted diatom microalgae-containing diets, although non-starch polysaccharide (NSP) degrading enzymes are commonly incorporated into diets for broiler chicks to improve the nutritive values (Lum et al., “Effects of Various Replacements of Corn and Soy by Defatted Microalgal Meal on Growth Performance and Biochemical Status of Weanling Pigs,” J. Anim. Sci. 90:701-701 (2012); Simbaya et al., “The Effects of Protease and Carbohydrase Supplementation on the Nutritive Value of Canola Meal for Poultry: In Vitro and In Vivo Studies,” Anim. Feed Sci. Technol. 61:219-234 (1996); Ghazi et al., “The Potential for the Improvement of the Nutritive Value of Soya-Bean Meal by Different Proteases in Broiler Chicks and Broiler Cockerels,” Br. Poult. Sci. 43:70-77 (2002); O'Shea et al., “The Effect of Protease and Xylanase Enzymes on Growth Performance, Nutrient Digestibility, and Manure Odour in Grower-Finisher Pigs,” Anim. Feed Sci. Technol. 189:88-97 (2014)). Supplementing NSP enzymes may be particularly useful in diets containing microalgae due to the presence of complex carbohydrates in their biomass (Brown et al., “Nutritional Properties of Microalgae for Mariculture,” Aquaculture 151:315-331 (1997); Chen et al., “Microalgae-Based Carbohydrates for Biofuel Production,” Biochem. Eng. J. 78:1-10 (2013)), and the other microalgal biomass may exhibit a different susceptibility to the extrinsic proteases from that of defatted diatom microalgae (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013)).

Although microalgae were explored as new or alternative protein supplements, previous research (Venkataraman et al., “Replacement Value of Blue-Green Alga (Spirulina platensis) for Fishmeal and a Vitamin-Mineral Premix for Broiler Chicks,” Br. Poult. Sci. 35:373-381 (1994); Becker, “Micro-Algae as a Source of Protein,” Biotechnol. Adv. 25:207-210 (2007)) did not examine impacts of feeding microalgae on body metabolism or underlying regulatory mechanism. Specifically, the mammalian target of rapamycin (mTOR) pathway is a key regulator of cell growth which integrates signals from nutrients, energy status, and growth factors to regulate metabolism (Sarbassov et al., “Growing Roles for the mTOR Pathway,” Curr. Opin. Cell Biol. 17:596-603 (2005)). Feeding regimes (Boussaid-Om et al., “Regulators of Protein Metabolism are Affected by Cyclical Nutritional Treatments with Diets Varying in Protein and Energy Content,” J. Nutr. Biochem. 23:1467-1473 (2012)), amino acid abundance and availability (Kimball et al., “Control of Protein Synthesis by Amino Acid Availability,” Curr. Opinion Clin. Nutr. Metab. Care 5:63-67 (2002); Kimball et al., “Signaling Pathways and Molecular Mechanisms Through which Branched-Chain Amino Acids Mediate Translational Control of Protein Synthesis,” J. Nutr. 136:227S-231S (2006)), protein abundance (Boussaid-Om et al., “Regulators of Protein Metabolism are Affected by Cyclical Nutritional Treatments with Diets Varying in Protein and Energy Content,” J. Nutr. Biochem. 23:1467-1473 (2012)) and protein source (Luo et al., “Effects of Different Dietary Protein Sources on Expression of Genes Related to Protein Metabolism in Growing Rats,” Br. J. Nutr. 104:1421 (2010)) are able to affect this pathway. Downstream targets of mTOR include eukaryotic translation initiation factor 4E-binding protein 1 (4E-BP1) and eukaryotic translation initiation factor 4E (eIF4E) that mediate steps in translation initiation and ribosomal protein S (S6) and ribosomal protein S6 kinase (S6K1) that are thought to regulate protein translation (Wang et al., “The mTOR Pathway in the Control of Protein Synthesis,” Physiol. 21:362-369 (2006)). Because broiler chicks go through intensive protein synthesis during the growth, it is not only novel but also relevant to determine effects of the microalgal biomass inclusion into their diets on their functional expression of signal proteins involved in the mTOR pathway.

Just as broiler chicks, weanling pigs grow at a fast rate with intensive protein metabolism (Robison, “Growth Patterns in Swine,” J. Anim. Sci. 42:1024-1035 (1976)). Likewise, previous research (Lum et al., “Effects of Various Replacements of Corn and Soy by Defatted Microalgal Meal on Growth Performance and Biochemical Status of Weanling Pigs,” J. Anim. Sci. 90:701-701 (2012)) showed that weanling pigs grew well with diets containing 7.5% defatted diatom microalgae to replace corn and soybean meal, but not with the 15% defatted diatom microalgae substitution for corn and soybean meal. Subsequently, the same question arose as if weanling pigs tolerated higher inclusion levels of the higher protein containing defatted green microalgal biomass. However, there were different considerations for the pig and chick studies. First, effects of the added microalgal biomass on plasma biochemical measures of nutritional status including tartrate-resistant acid phosphatase (“TRAP”), alkaline phosphatase (“AKP”), and alanine aminotransferase (“ALT”) (Isaacs et al., “A Partial Replacement of Soybean Meal by whole or Defatted Algal Meal in Diet for Weanling Pigs Does not Affect their Plasma Biochemical Indicators,” J. of Animal Sci. 89:723-723 (2011)) were less certain in pigs than those in the broiler studies. Plasma urea nitrogen (“PUN”) and amino acid profiles are often used to estimate nutritional values of feed proteins in pigs (Kohn et al., “Using Blood Urea Nitrogen to Predict Nitrogen Excretion and Efficiency of Nitrogen Utilization in Cattle, Sheep, Goats, Horses, Pigs, and Rats,” J. Anim. Sci. 83:879-889 (2005)). While it is convenient in pigs, but not possible in chicks, to include chromium oxide in diets as an indicator for estimating apparent total tract digestibility of total amino acids (Stein et al., “Comparative Protein and Amino Acid Digestibilities in Growing Pigs and Sows,” J. Anim. Sci. 77:1169-1179 (1999)), it is more difficult and expensive to sample tissues from the former than from the latter to study metabolic regulation of dietary treatments (Suryawan et al., “Developmental Regulation of the Activation of Signaling Components Leading to Translation Initiation in Skeletal Muscle of Neonatal Pigs,” Am. J. Physiol. Endocrinol. Metab. 291:E849-59 (2006); Escobar et al., “Amino Acid Availability and Age Affect the Leucine Stimulation of Protein Synthesis and eIF4F Formation in Muscle,” Am. J. Physiol. Endocrinol. Metab. 293:E1615-21 (2007)). In addition, only extrinsic proteases, but not NSP enzymes, are often supplemented in diets for weanling pigs (Guggenbuhl et al., “Effects of Dietary Supplementation with a Protease on the Apparent Ileal Digestibility of the Weaned Piglet,” J. Anim. Sci. 90(Suppl 4):152-154 (2012)).

In an earlier 8-wk study (Leng et al., “Defatted Algae Biomass may Replace One-Third of Soybean Meal in Diets for Laying Hens,” J. Anim. Sci. 90(Supp1.3):701 (2012)), it was found that laying hens tolerated 7.5%, but not 15%, of defatted diatom (Staurosira sp) microalgae. Plasma uric acid, the primary nitrogen excretion product in birds, was found to be lower at 15% inclusion compared with lower inclusion rates and the control group. Furthermore, 15% algae inclusion recovered diminished albumen weight found with 7.5% algae inclusion.

Protein quality and composition can impact several transport systems, including the cationic amino acid transporter (“CAT”) family, the oligopeptide transporter 1 (“PEPT”), and the Na²⁺-independent branched chain and amino acid transporter (“LAT”) and intestinal enzymes such as aminopeptidases (“APN”) (Gilbert et al., “Developmental Regulation of Nutrient Transporter and Enzyme mRNA Abundance in the Small Intestine of Broilers,” Poult. Sci. 86:1739-1753 (2007); Gilbert et al., “Dietary Protein Quality and Feed Restriction Influence Abundance Nutrient Transporter mRNA in the Small Intestine of Broiler Chicks,” J. Nutr. 138:262-271 (2008); Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010); Speier et al., “Gene Expression of Nutrient Transporters and Digestive Enzymes in the Yolk Sac Membrane and Small Intestine of the Developing Embryonic Chick,” Poult. Sci. 91:1941-1949 (2012)). Phosphorylation of S6 ribosomal protein (S6) and its up-stream regulators including P70 S6 kinase 1 (P70) and the mammalian target of rapamycin (mTOR), along with the eukaryotic initiation factor 4E (e1F4E) play important roles in the initiating protein synthesis and are responsive to dietary protein changes.

Many questions arose from this study and other similar experiments (Blum et al., “Food Value of Spiruline Algae for Growth of the Broiler-Type Chicken,” Annales de la Nutrition et de l'Alimentation 29:651-674 (1975); Lipstein et al., “The Nutritional Value of Algae for Poultry. Dried Chlorella in Layer Diets,” Br. Poultry Sci. 21:23-27 (1980); Ginzberg et al., “Chickens Fed with Biomass of the Red Microalga Porphyridium sp. Have Reduced Blood Cholesterol Level and Modified Fatty Acid Composition in Egg Yolk,” J. Appl. Phycol. 12:325-330 (2000); Al-Harthi et al., “The Effects of Preparing Methods and Enzyme Supplementation on the Utilization of Brown Marine Algae (Sarassum dentifebium) Meal in the Diet of Laying Hens,” Italian J. Anim. Sci. 10:195-203 (2011); Halle et al., “Effect of Microalgae Chlorella Vulgaris on Laying Hen Performance,” Archiva Zootechnica 12:5-13 (2009); El-Deek et al., “The Use of Brown Algae Meal in Finisher Broiler Diets,” Egypt. Poult. Sci. 31:767-781 (2011)).

The present invention is directed to overcoming deficiencies in the art pertaining to algal-based animal feed.

### SUMMARY OF THE INVENTION

One aspect of the present invention relates to an animal feed composition comprising one or more grains in an amount totaling 48-70% w/w of the composition; a non-algal protein source in an amount totaling 15-30% w/w of the composition; algae in an amount totaling 3-15% w/w of the composition; an exogenous protease totaling 0.01-0.1% w/w of the composition; and an oil heterologous to the algae in an amount totaling 0.5-15% w/w of the composition.

Another aspect of the present invention relates to an animal feed supplement comprising algae, an exogenous protease, and an oil heterologous to the algae.

A further aspect of the present invention relates to a method of feeding an animal. This method involves administering to an animal the animal feed composition of the present invention.

Yet another aspect of the present invention relates to a method of feeding an animal. This method involves administering to an animal an animal feed in combination with the animal feed supplement of the present invention.

Yet a further aspect of the present invention relates to a method of improving the feed efficiency of an animal. This method involves administering to an animal an animal feed in combination with the animal feed supplement of the present invention under conditions effective to cause a decrease in plasma nitrogen concentration in the animal relative to such animal receiving the animal feed without the animal feed supplement, thereby improving the feed efficiency in the animal.

Another aspect of the present invention relates to a method of improving the feed efficiency of an animal. This method involves administering to an animal the animal feed composition of the present invention under conditions effective to cause a decrease in plasma nitrogen concentration in the animal relative to such animal receiving an animal feed other than the animal feed composition, thereby improving the feed efficiency in the animal.

In a further aspect, the present invention relates to, in an animal feed, the improvement comprising algae and an exogenous protease, where the algae and exogenous protease are in an amount effective to cause a decrease in plasma nitrogen concentration in an animal fed the animal feed.

As part of the present invention, two parallel pig and broiler experiments were conducted to determine nutritional and metabolic values of a new defatted green microalgal (Desmodesmus sp., Cellana, Kailua-Kona, Hi.) biomass from biofuel research that contained 31.2% crude protein. Objectives of the pig experiment (I) were to determine impacts of including 10% defatted green microalgal biomass (“DGM”) and(or) 0.06% protease on growth performance, plasma levels of TRAP, AKP, ALT, urea nitrogen, uric acid, and amino acids, and apparent total tract digestibility of total amino acids. Objectives of the chick experiment (II) were to determine impacts of including 15% DGM and(or) 0.06% protease or NSP enzymes on growth performance, plasma levels of uric acid and amino acids, and production of signal proteins related to the mTOR pathway in liver and muscle.

In addition, in the present invention, two sources of microalgal biomass were obtained: defatted green and full-fatted diatom, and a layer hen trial was conducted for 14 weeks. The objective was to determine how these two microalgae affected egg production and quality, physiological status, and protein digestion and metabolism, including intestinal gene expression and hepatic protein production of molecules-related to amino acid digestion, uptake, and synthesis (Gilbert et al., “Dietary Protein Quality and Feed Restriction Influence Abundance Nutrient Transporter mRNA in the Small Intestine of Broiler Chicks,” J. Nutr. 138:262-271 (2008); Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010); which are hereby incorporated by reference in their entirety). Because exogenous hydrolytic enzymes may aid in the digestion of microalgae (Al-Harthi et al., “The Effects of Preparing Methods and Enzyme Supplementation on the Utilization of Brown Marine Algae (Sarassum dentifebium) Meal in the Diet of Laying Hens,” Italian J. Anim. Sci. 10:195-203 (2011), which is hereby incorporated by reference in its entirety), effects of adding a commercially-available protease into the two algal diets for the hens was also compared.

### BRIEF DESCRIPTION OF THE DRAWINGS

FIG. 1 shows the effects of defatted green microalgal biomass (DGM) and hydrolytic enzymes on protein and phosphorylation levels of protein biosynthesis regulators in liver of broilers. Data are expressed as means±SEM (n=3). Values are expressed as a ratio to β-actin, and then normalized to the control. Blots are representative of three independent replicate gels. *Significant effect of DGM vs. control (P<0.05), **Trending effect of DGM vs. control (P<0.10), †-Significant effect of protease vs. treatments own control (P<0.05), ††Trending effect of protease vs. treatments own control (P<0.10), ‡Significant effect of NSPase vs. treatments own control (P<0.05), ‡‡Trending effect of NSPase vs. treatments own control (P<0.10). eIF4E, eukaryotic initiation factor 4E; p70, p70 S6 kinase; S6, S6 ribosomal protein; pS6, phospho-S6 ribosomal protein; and mTOR, mammalian target of rapamycin.

FIG. 2 shows the effects of defatted green microalgal biomass (DGM) and hydrolytic enzymes on protein and phosphorylation levels of protein biosynthesis regulators in muscle of broilers. Data are expressed as means±SEM (n=3). Values are expressed as a ratio to β-actin, and then normalized to the control. Blots are representative of three independent replicate gels. *Significant effect of DGM vs. control (P<0.05), **Trending effect of DGM vs. control (P<0.10), †Significant effect of protease vs. treatments own control (P<0.05), if Trending effect of protease vs. treatments own control (P<0.10), Significant effect of NSPase vs. treatments own control (P<0.05), ‡‡Trending effect of NSPase vs. treatments own control (P<0.10). eIF4E, eukaryotic initiation factor 4E; p70, p70 S6 kinase; S6, S6 ribosomal protein; pS6, phospho-S6 ribosomal protein; and mTOR, mammalian target of rapamycin.

FIG. 3 shows the effect of dietary algae inclusion with and without protease supplementation on hepatic protein levels of protein synthesis-related key regulators at week 14. Values under bands of each group are expressed as mean±SE. eIF4E, eukaryotic initiation factor 4E; mTOR, the mammalian target of rapamycin; P70, P70 S6 kinase; S6, S6 ribosomal protein; and PS6, phospho-S6 ribosomal protein.

### DETAILED DESCRIPTION OF THE INVENTION

The present invention relates generally to animal feed compositions and animal feed supplements containing, inter alia, microalgae and exogenous protease. While the inclusion of algae in animal feed is known, the present invention relates to improved algal-based animal feed compositions and animal feed supplements that provide a combination of ingredients that improve existing animal feed.

One aspect of the present invention relates to an animal feed composition comprising one or more grains in an amount totaling 48-70% w/w of the composition; a non-algal protein source in an amount totaling 15-30% w/w of the composition; algae in an amount totaling 3-15% w/w of the composition; an exogenous protease totaling 0.01-0.1% w/w of the composition; and an oil heterologous to the algae in an amount totaling 0.5-15% w/w of the composition.

In one embodiment, the animal feed composition comprises one or more grains in an amount of 51-69%, 52-68%, 53-67%, 54-66%, 55-65%, 56-64%, 57-63%, 58-62%, 59-61%, or about 60% w/w of the composition. Alternatively, the animal feed composition comprises one or more grains in an amount of about 50%, 51%, 52%, 53%, 54%, 55%, 56%, 57%, 58%, 59%, 60%, 61%, 62%, 63%, 64%, 65%, 66%, 67%, 68%, 69%, or 70% w/w of the composition.

In one embodiment, the animal feed composition comprises a non-algal protein source in an amount totaling 16-29%, 17-28%, 18-27%, 19-26%, 20-25%, 21-24%, or 22-23% w/w of the composition. Alternatively, the animal feed composition comprises one or more grains in an amount of about 16%, 17%, 18%, 19%, 20%, 21%, 22%, 23%, 24%, 25%, 26%, 27%, 28%, 29%, or 30% w/w of the composition.

In one embodiment, the animal feed composition comprises algae in an amount totaling 4-14%, 5-13%, 6-12%, 7-11%, 8-10%, or about 9% w/w of the composition. Alternatively, the animal feed composition comprises algae in an amount of about 3%, 4%, 5%, 6%, 7%, 7.5%, 8%, 9%, 10%, 11%, 12%, 13%, 14%, or 15% w/w of the composition.

In one embodiment, the animal feed composition comprises an exogenous protease totaling 0.02-0.09%, 0.03-0.08, 0.04-0.07, 0.05-0.06, or about 0.05 w/w of the composition. Alternatively, the animal feed composition comprises algae in an amount of about 0.01%, 0.02%, 0.03%, 0.04%, 0.05%, 0.06%, 0.07%, 0.08%, 0.09%, or 0.1% w/w of the composition.

In one embodiment, the animal feed composition comprises an oil heterologous to the algae in an amount totaling 0.6-14%, 0.7-13%, 0.8-12%, 0.9-11%, 1-10%, 2-9%, 3-8%, 4-7%, or 5-6% w/w of the composition. Alternatively, the animal feed composition comprises oil heterologous to the algae in an amount of about 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, 9.5%, 10%, 11%, 12%, 13%, 14%, or 15% w/w of the composition.

In one embodiment, the animal feed composition further comprises an inorganic phosphate source in an amount totaling up to 1.5%, 1.4%, 1.3%, 1.2%, 1.1%, 1.0%, 0.9%, 0.8%, 0.7%, 0.6%, 0.5%, 0.4%, 0.3%, 0.2%, 0.1%, 0.05%, or 0.01% w/w of the composition.

In one embodiment, the animal feed composition further comprises a sodium source in an amount totaling up to 0.5%, 0.4%, 0.3%, 0.2%, 0.1%, 0.09%, 0.08%, 0.07%, 0.06%, 0.05%, or 0.01% w/w of the composition.

In one embodiment, the animal feed composition further comprises one or more amino acids selected from the group consisting of lysine, threonine, isoleucine, tryptophan, and methionine in an amount totaling up to 0.5%, 0.4%, 0.3%, 0.2%, 0.1%, 0.09%, 0.08%, 0.07%, 0.06%, 0.05%, or 0.01% w/w of the composition.

Another aspect of the present invention relates to an animal feed supplement comprising algae, an exogenous protease, and an oil heterologous to the algae.

As used herein, “w/w” refers to proportions by weight, and means the ratio of the weight of one substance in a composition to the total weight of the composition, or the weight of one substance in the composition to the weight of another substance of the composition. For example, reference to a composition that comprises algae totaling 15% w/w of the composition means that 15% of the composition's weight is composed of algae (e.g., such a composition having a weight of 100 mg would contain 15 mg of algae) and the remainder of the weight of the composition (e.g., 85 mg in this example) is composed of other ingredients.

As used herein, the terms “microalgae” and “algae” are used interchangeably and mean a eukaryotic microbial organism that contains a chloroplast, and which may or may not be capable of performing photosynthesis. Microalgae include obligate photoautotrophs which cannot metabolize a fixed carbon source as energy, as well as heterotrophs, which can live solely off of a fixed carbon source, including obligate heterotrophs, which cannot perform photosynthesis. Microalgae include unicellular organisms that separate from sister cells shortly after cell division, such as Chlamydomonas, as well as microbes such as, for example, Volvox, which is a simple multicellular photosynthetic microbe of two distinct cell types.

In one embodiment, the algae or microalgae is the green marine algae Desmodesmus sp. Other microalgae may include cells such as Chlorella, Parachlorella, and Dunaliella. Chlorella is a genus of single-celled green algae, belonging to the phylum Chlorophyta. Chlorella cells are generally spherical in shape, about 2 to 10 μm in diameter, and lack flagella. Some species of Chlorella are naturally heterotrophic. Non-limiting examples of Chlorella species suitable for use in the animal feed and animal feed supplements of the present invention include Chlorella protothecoides, Chlorella ellipsoidea, Chlorella minutissima, Chlorella zofinienesi, Chlorella luteoviridis, Chlorella kessleri, Chlorella sorokiniana, Chlorella fusca var. vacuolata Chlorella sp., Chlorella cf. minutissima, and Chlorella emersonii. Chlorella protothecoides, is known to have a high composition of lipids.

Other species of Chlorella suitable for use in the animal feed and animal feed supplement compositions of the present invention include, without limitation, the species anitrata, antarctica, aureoviridis, candida, capsulate, desiccate, ellipsoidea (including strain CCAP 211/42), glucotropha, infusionum (including var. actophila and var. auxenophila), kessleri (including any of UTEX strains 397, 2229, 398), lobophora (including strain SAG 37.88), luteoviridis (including strain SAG 2203 and var. aureoviridis and lutescens), miniata, mutabilis, nocturna, ovalis, parva, photophila, pringsheimii, protothecoides (including any of UTEX strains 1806, 411, 264, 256, 255, 250, 249, 31, 29, 25 or CCAP 211/8D, or CCAP 211/17 and var. acidicola), regularis (including var. minima, and umbricata), reisiglii (including strain CCP 11/8), saccharophila (including strain CCAP 211/31, CCAP 211/32 and var. ellipsoidea), salina, simplex, sorokiniana (including strain SAG 211.40B), sphaerica, stigmatophora, trebouxioides, vanniellii, vulgaris (including strains CCAP 211/11K, CCAP 211/80 and F. tertia and var. autotrophica, viridis, vulgaris, tertia, viridis), xanthella, and zofingiensis.

Other genera of microalgae can also be used in the animal feed compositions of the present invention and may include, for example, Parachlorella kessleri, Parachlorella beijerinckii, Neochloris oleabundans, Bracteacoccus, including B. grandis, B. cinnabarinas, and B. aerius, Bracteococcus sp. and Scenedesmus rebescens. Other nonlimiting examples of microalgae species include Achnanthes orientalis; Agmenellum; Amphiprora hyaline; Amphora, including A. coffeiformis including A.c. linea, A.c. punctata, A.c. taylori, A.c. tenuis, A.c. delicatissima, A.c. delicatissima capitata; Anabaena; Ankistrodesmus, including A. falcatus; Boekelovia hooglandii; Borodinella; Botryococcus braunii, including B. sudeticus; Bracteoccocus, including B. aerius, B. grandis, B. cinnabarinas, B. minor, and B. medionucleatus; Carteria; Chaetoceros, including C. gracilis, C. muelleri, and C. muelleri subsalsum; Chlorococcum, including C. infusionum; Chlorogonium; Chroomonas; Chrysosphaera; Cricosphaera; Crypthecodinium cohnii; Cryptomonas; Cyclotella, including C. cryptica and C. meneghiniana; Desmodesmus; Dunaliella, including D. bardawil, D. bioculata, D. granulate, D. maritime, D. minuta, D. parva, D. peircei, D. primolecta, D. salina, D. terricola, D. tertiolecta, and D. viridis; Eremosphaera, including E. viridis; Ellipsoidon; Euglena; Franceia; Fragilaria, including F. crotonensis; Gleocapsa; Gloeothamnion; Hymenomonas; Isochrysis, including I. aff galbana and I. galbana; Lepocinclis; Micractinium (including UTEX LB 2614); Monoraphidium, including M. minutum; Monoraphidium; Nannochloris; Nannochloropsis, including N. salina; N. avicula, including N. acceptata, N. biskanterae, N. pseudotenelloides, N. pelliculosa, and N. saprophila; Neochloris oleabundans; Nephrochloris; Nephroselmis; Nitschia communis; Nitzschia, including N. alexandrine, N. communis, N. dissipata, N. frustulum, N. hantzschiana, N. inconspicua, N. intermedia, N. microcephala, N. pusilla, N. pusilla elliptica, N. pusilla monoensis, and N. quadrangular; Ochromonas; Oocystis, including O. parva and O. pusilla; Oscillatoria, including O. limnetica and O. subbrevis; Parachlorella, including P. beijerinckii (including strain SAG 2046) and P. kessleri (including any of SAG strains 11.80, 14.82, 21.11H9); Pascheria, including P. acidophila; Pavlova; Phagus; Phormidium; Platymonas; Pleurochrysis, including P. carterae and P. dentate; Prototheca, including P. stagnora (including UTEX 327), P. portoricensis, and P. moriformis (including UTEX strains 1441, 1435, 1436, 1437, 1439); Pseudochlorella aquatica; Pyramimonas; Pyrobotrys; Rhodococcus opacus; Sarcinoid chrysophyte; Scenedesmus, including S. armatus and S. rubescens; Schizochytrium; Spirogyra; Spirulina platensis; Stichococcus; Synechococcus; Tetraedron; Tetraselmis, including T. suecica; Thalassiosira weissflogii; and Viridiella fridericiana.

The algae or microalgae may also be a diatom, e.g., diatom microalgae Staurosira sp. or Nannofrustulum. Diatoms are the major phytoplankton characterized by silica in the outer membrane of their cell walls. Diatoms construct ornamented shells of amorphous silica that contain complex material in their frustule structure. Studies on diatoms show that in some species, total amino acids found in the cell wall are 1.2-fold greater than those found in the cell contents. Also, certain amino acids appear to be consistently enriched in the cell wall compared to the cell contents, such as serine, threonine, and glycine.

A suitable source of microalgae for the animal feed composition and animal feed supplement of the present invention is algal biomass. Algal biomass is material produced by growth and/or propagation of microalgal cells. Biomass may contain cells and/or intracellular contents as well as extracellular material. Extracellular material includes, but is not limited to, compounds secreted by a cell.

Typically, microalgae are cultured in liquid media to propagate biomass. For example, microalgal species may be grown in a medium containing a fixed carbon and/or fixed nitrogen source in the absence of light. Such growth is known as heterotrophic growth. For some species of microalgae, heterotrophic growth for extended periods of time such as 10 to 15 or more days under limited nitrogen conditions results in accumulation of high lipid content in the microalgal cells.

One particularly suitable source of microalgae for use in the present invention is microalgae cultivated for biofuel production. Microalgae cultivated for biofuel production includes algae before oils have been harvested from the algae (full-fat algae) and algae that has undergone oil extraction (defatted algae). Thus, as used herein, defatted algae has undergone an oil extraction process and so contains less oil relative to algae prior to oil extraction. Cells of defatted algae are predominantly lysed. Defatted algae include algal biomass that has been solvent (hexane) extracted.

Oils harvested from algae include any triacylglyceride (or triglyceride oil) produced by algae. Defatted algae contain less oil by dry weight or volume than the microalgae contained before extraction. In one embodiment, defatted algae include algae having 50-90% of its oil extracted so that the defatted algae contains, for example about 10-50% of the oil content of biomass before extraction. However, the biomass still has a high nutrient value in content of protein and other constituents which makes it suitable for use in animal feed.

The process of preparing defatted (or delipidated) algae for use in the animal feed composition and supplement of the present invention can be carried out by standard methods known to those of ordinary skill in the art. For example, algal cells can be lysed, which can be achieved by any convenient means, including heat-induced lysis, adding a base, adding an acid, using enzymes such as proteases and polysaccharide degradation enzymes such as amylases, using ultrasound, mechanical pressure-based lysis, and lysis using osmotic shock. Each of these methods for lysing a microorganism can be used as a single method or in combination simultaneously or sequentially. The extent of cell disruption can be observed by microscopic analysis. Using one or more of the methods above, typically more than 70% cell breakage is observed.

Lipids and oils generated by the microalgae can be recovered by extraction. In some cases, extraction can be performed using an organic solvent or an oil, or can be performed using a solventless-extraction procedure.

For organic solvent extraction of the microalgal oil, the preferred organic solvent is hexane. Typically, the organic solvent is added directly to the lysate without prior separation of the lysate components. In one embodiment, the lysate generated by one or more of the methods described above is contacted with an organic solvent for a period of time sufficient to allow the lipid components to form a solution with the organic solvent. In some cases, the solution can then be further refined to recover specific desired lipid components. The mixture can then be filtered and the hexane removed by, for example, rotoevaporation. Hexane extraction methods are well known in the art (see, e.g., Frenz et al., “Hydrocarbon Recovery by Extraction with a Biocompatible Solvent from Free and Immobilized Cultures of Botryococcus-braunii,” Enzyme Microb. Technol. 11:717-724 (1989), which is hereby incorporated by reference in its entirety.

Miao and Wu, “Biodiesel Production from Heterotrophic Microalgal Oil,” Biosource Technology 97:841-846 (2006), which is hereby incorporated by reference in its entirety, describe a protocol of the recovery of microalgal lipid from a culture of Chlorella protothecoides in which the cells were harvested by centrifugation, washed with distilled water, and dried by freeze drying. The resulting cell powder was pulverized in a mortar and then extracted with n-hexane.

In some cases, microalgal oils can be extracted using liquefaction (see, e.g., Sawayama et al., “Possibility of Renewable Energy Production and CO₂ Mitigation by Thermochemical Liquefaction of Microalgae,” Biomass and Bioenergy 17:33-39 (1999), which is hereby incorporated by reference in its entirety); oil liquefaction (see, e.g., Minowa et al., “Oil Production from Algal Cells of Dunaliella tertiolecta by Direct Thermochemical Liquefaction,” Fuel 74(12):1735-1738 (1995), which is hereby incorporated by reference in its entirety); or supercritical CO₂ extraction (see, e.g., Mendes et al., “Supercritical Carbon Dioxide Extraction of Compounds with Pharmaceutical Importance from Microalgae,” Inorganica Chimica Acta 356:328-334 (2003), which is hereby incorporated by reference in its entirety). Algal oil extracted via supercritical CO₂ extraction contains all of the sterols and carotenoids from the algal biomass and naturally do not contain phospholipids as a function of the extraction process. The residual from the processes essentially comprises defatted (or delipidated) algal biomass devoid of oil, but still retains the protein and carbohydrates of the pre-extraction algal biomass. Thus, the residual defatted algal biomass is a suitable source of protein concentrate/isolate and dietary fiber.

Oil extraction also includes the addition of an oil directly to a lysate without prior separation of the lysate components. After addition of the oil, the lysate separates either of its own accord or as a result of centrifugation or the like into different layers. The layers can include in order of decreasing density: a pellet of heavy solids, an aqueous phase, an emulsion phase, and an oil phase. The emulsion phase is an emulsion of lipids and aqueous phase. Depending on the percentage of oil added with respect to the lysate (w/w or v/v), the force of centrifugation, if any, volume of aqueous media, and other factors, either or both of the emulsion and oil phases can be present. Incubation or treatment of the cell lysate or the emulsion phase with the oil is performed for a time sufficient to allow the lipid produced by the microorganism to become solubilized in the oil to form a heterogeneous mixture.

Lipids can also be extracted from a lysate via a solventless extraction procedure without substantial or any use of organic solvents or oils by cooling the lysate. Sonication can also be used, particularly if the temperature is between room temperature and 65° C. Such a lysate on centrifugation or settling can be separated into layers, one of which is an aqueous:lipid layer. Other layers can include a solid pellet, an aqueous layer, and a lipid layer. Lipid can be extracted from the emulsion layer by freeze thawing or otherwise cooling the emulsion. In such methods, it is not necessary to add any organic solvent or oil. If any solvent or oil is added, it can be below 5% v/v or w/w of the lysate.

Algae used in the composition and feed supplement of the present invention is typically dried and/or ground into algal meal. Drying microalgal biomass, either predominantly intact or in homogenate form, is advantageous to facilitate further processing or for use of the biomass in the composition and feed supplement of the present invention. Drying refers to the removal of free or surface moisture/water from predominantly intact biomass or the removal of surface water from a slurry of homogenized (e.g., by micronization) biomass. In some cases, drying the biomass may facilitate a more efficient microalgal oil extraction process.

In one embodiment, concentrated microalgal biomass is drum dried to a flake form to produce algal flake. In another embodiment, the concentrated microalgal biomass is spray or flash dried (i.e., subjected to a pneumatic drying process) to form a powder containing predominantly intact cells to produce algal powder. In another embodiment, the concentrated microalgal biomass is micronized (homogenized) to form a homogenate of predominantly lysed cells that is then spray or flash dried to produce algal flour.

In certain embodiments, the algae component of the composition and/or feed supplement of the present invention is in the form of flour, flake, or powder and contains 15% or less, 10% or less, 5% or less, 2-6%, or 3-5% moisture by weight after drying.

The algae of the animal feed composition and/or animal feed supplement of the present invention may include only full-fat algae, only defatted (or delipidated) algae, or combinations thereof. When a full-fat algae is used in the animal feed composition, it may be desirable to reduce the amount of oil heterologous to the algae, particularly when more full-fat algae is present than defatted algae. Thus, for example, in one embodiment the animal feed composition includes more full-fat algae than defatted algae and the oil heterologous to the algae is present in the composition in an amount totaling 0.5-5% w/w of the composition. In another embodiment, the animal feed composition includes more defatted algae than full-fat algae and the oil heterologous to the algae is present in the composition in an amount totaling 3-15% w/w of the composition.

The algae component of the animal feed composition and animal feed supplement of the present invention may be substituted in the animal feed composition and animal feed supplement for another protein source having similar nutrient qualities to algae.

As used herein, exogenous protease means protease that is not a component of any of the other ingredients of the animal feed composition or supplement of the present invention (e.g., grain, protein, or algae), or is protease in addition to any protease that may be part of one or more of the components of the animal feed composition or supplement of the present invention. Exogenous proteases have been used in animal feed. However, in the present invention, exogenous proteases are shown in the inventive compositions to have an unexpected benefit when used in combination with the algae (and other compositional components) in the compositions of the present invention. Specific suitable proteases include, without limitation, RONOZYME® ProAct, TfpA, trypsin, pepsin, keratinase, proteinase K, peptidase, etc.

In one embodiment of the animal feed composition and animal feed supplement, the oil heterologous to the algae comprises corn oil, although other types of oil may be used, including, without limitation, vegetable or seed oils derived from plants, including without limitation, oil derived from soy, rapeseed, canola, palm, palm kernel, coconut, corn, olive, sunflower, cotton seed, cuphea, peanut, camelina sativa, mustard seed, cashew nut, oats, lupine, kenaf, calendula, hemp, coffee, linseed, hazelnut, euphorbia, pumpkin seed, coriander, camellia, sesame, safflower, rice, tung oil tree, cocoa, copra, pium poppy, castor beans, pecan, jojoba, jatropha, macadamia, Brazil nuts, avocado, and combinations thereof. In one embodiment, the oil in the animal feed composition and/or supplement of the present invention is pure concentrated oil.

In the animal feed composition of the present invention, one or more grains are present in an amount totaling 48-70% w/w of the composition. Suitable grains include those commonly fed to animals, including, without limitation, maize, wheat, rice, sorghum, oats, potato, sweet potato, cassava, DDGS, and combinations thereof.

The animal feed composition of the present invention also includes a non-algal protein source in an amount totaling 15-30% w/w of the composition. Non-algal protein sources include those commonly part of animal feed, including, without limitation, meat, fish protein, soy protein, whey protein, wheat protein, bean protein, rice protein, pea protein, milk protein, etc. In one embodiment, the non-algal protein source is soybean, fishmeal, cottonseed meal, rapeseed meal, meat meal, plasma protein, blood meal, or combinations thereof.

In the animal feed composition of the present invention, an inorganic phosphate source may be present in an amount totaling up to 1.5% w/w of the composition. High quality inorganic phosphates offer the combination of a consistently high total phosphorus content and excellent digestibility and are therefore widely used as supplemental phosphorus. Most inorganic phosphates used for this purpose are derived from natural rock phosphates, principally found in Africa, northern Europe, Asia, the Middle East and the United States. However, in their natural form these are unsuitable for direct use in animal feed because the phosphorus they contain cannot be metabolized by animals. Rock phosphates must therefore be chemically treated so that the phosphorus they contain is changed into the digestible orthophosphate form (PO4³-). During this process, close control of the production parameters is essential to avoid deterioration of the orthophosphate molecule into other unavailable forms of phosphorus, such as pyro- and meta-phosphate, and to ensure a suitable calcium to phosphorus ratio for animal nutrition. Furthermore, rock phosphates also contain impurities, such a fluorine, cadmium, and arsenic which, if not removed in the production process, make them unsuitable for animal nutrition. In one embodiment, the phosphate source in the animal feed composition of the present invention comprises dicalcium phosphate.

The animal feed composition of the present invention may further include any one or more of the following: plasma protein in an amount totaling 0.5-3.0% w/w of the composition; an inorganic calcium source in an amount totaling 0.1-10% w/w of the composition; a vitamin/mineral mix in an amount totaling 0.1-1% w/w of the composition, where the vitamin/mineral mix comprises one or more trace minerals (e.g., selected from Cu, Se, Zn, I, Mn, Fe, Co, and combinations thereof); an inorganic magnesium source in an amount totaling 0.01-0.1% w/w of the composition; and an antibiotic in an amount totaling 0.01-0.1% w/w of the composition.

Similarly, the animal feed supplement of the present invention may further include one or more of the following: plasma protein; an inorganic calcium source; a vitamin/mineral mix; an inorganic magnesium source; and an antibiotic.

Plasma protein is obtained by collecting blood from animals, preferably pigs or cows. For example, blood is collected at slaughter plants. As it is collected, the blood is held in a circulating stainless steel tank with anticoagulants such as sodium citrate or sodium phosphate to avoid clotting. The whole blood is then separated, likely by centrifugation into two parts, cellular material (red corpuscles, white corpuscles, and platelets) and plasma. Plasma is composed of about 60% albumin and about 40% globulin. After separation, the plasma is cooled in an insulated tanker until ready to dry.

The plasma component is then further concentrated 2 to 3 fold by membrane filtration. At this stage, a microbial fermentation extract containing primarily amylase may be added. Thus, in one embodiment, animal plasma protein may be combined with a microbial fermentation product with a significant level of amylase activity (see U.S. Pat. No. 5,372,811 to Yoder, which is hereby incorporated by reference in its entirety). The mixture is blended for 10 minutes and finally is co-dried to form a beige powdery substance. Spray drying should occur at temperatures low enough to maintain the highly digestible proteins but high enough to purify the dry powder eliminating bacterial and viral contamination.

Spray dried animal plasma protein has traditionally been used as a high quality protein used as a replacement for milk proteins due to its high quality protein and immunoglobulin content. This plasma has also been used in the feed industry as a feed supplement ingredient for veal and calf milk replacers, aquaculture, and pet food for its influence on voluntary feed intake and efficient gains equal to or better than milk proteins. In one embodiment, the animal plasma protein used in the animal feed and feed supplement compositions of the present invention is comprised of high levels of amino acids.

Inorganic calcium sources for use in the composition and animal feed supplement of the present invention are well known. In one embodiment, the inorganic calcium source is limestone (calcium carbonate). In other embodiments, the inorganic calcium source is from one or more of the three supplemental sources of inorganic calcium of calcite flour, aragonite, and albacar (see Wohlt et al., “Calcium Sources for Milk Production in Holstein Cows via Changes in Dry Matter Intake, Mineral Utilization, and Mineral Source Buffering Potential,” J. Dairy Sci. 70:2812 (1987), which is hereby incorporated by reference in its entirety). Each of these inorganic calcium sources differs in particle size and rate of reactivity.

Suitable vitamin/mineral mix for use in the animal feed composition and/or supplement of the present invention may include, for example, vitamin A, vitamin D₃, vitamin E, vitamin K, biotin, choline, choline chloride, folacin, folic acid, niacin, pantothenic acid, d-calcium pantothenate, pyridoxine hydrochloride, nicotinic acid, cyanocobalamin, riboflavin, thiamin, thiamine hydrochloride, menadione sodium bisulfite, ethoxyquin, vitamin B₆, vitamin B₁₂, Cu, I, Mn, Zn, Se, Mg, Co, or Fe, and combinations thereof.

Magnesium oxide (MgO) is a widely available inorganic magnesium source, in many different forms for different uses. Generally, an MgO intended for animal feed use is preferred, and a number of commercial suppliers are available.

Suitable antibiotics for the animal feed composition and supplement of the present invention may include, for example, tetracyclines, bacitracin, avilamycin, nicarbazin, tylosin (as tylosin phosphate), tiamulin, lincomycin, virginiamycin, quinolone antibacterials, carbadox, chlortetracycline hydrochloride, and combinations thereof.

In addition to one or more of the amino acids lysine, threonine, isoleucine, tryptophan, and methionine, other amino acids may be included in the animal feed composition and/or animal feed supplement of the present invention.

A further aspect of the present invention relates to a method of feeding an animal. This method involves administering to an animal the animal feed composition of the present invention. Yet another aspect of the present invention involves administering to an animal an animal feed in combination with the animal feed supplement of the present invention.

Yet a further aspect of the present invention relates to a method of improving the feed efficiency of an animal. This method involves administering to an animal an animal feed in combination with the animal feed supplement of the present invention under conditions effective to cause a decrease in plasma nitrogen concentration in the animal relative to such animal receiving the animal feed without the animal feed supplement, thereby improving the feed efficiency in the animal.

Another aspect of the present invention relates to a method of improving the feed efficiency of an animal. This method involves administering to an animal the animal feed composition of the present invention under conditions effective to cause a decrease in plasma nitrogen concentration in the animal relative to such animal receiving an animal feed other than the animal feed composition, thereby improving the feed efficiency in the animal.

In a further aspect, the present invention relates to, in an animal feed, the improvement comprising algae and an exogenous protease, where the algae and exogenous protease are in an amount effective to a decrease in plasma nitrogen concentration in an animal fed the animal feed.

Decreasing plasma nitrogen concentration in an animal according to the methods of the present invention may include, for example, a decrease of at least about up to 5%, 10%, 15%, 20%, 25%, 30%, 35%, 40%, 45%, or 50% after about 5, 10, 11, 12, 13, 14, 15, 16, 17, 18, 19, 20, 21, 22, 23, 24, 25, or more days following administering to the animal the animal feed composition and/or supplement according to the method of the present invention.

Algae, either full fat or defatted, contains high quality proteins, carbohydrates, fiber, ash, and other nutrients appropriate for animal feed. Animals that may be fed with the animal feed composition and/or animal feed supplement of the present invention include, without limitation, a ruminant, poultry, swine, aquaculture, pet, dog, cat, horse, zoo animal, mouse, rat, rabbit, guinea pig, and hamster. In one embodiment, the animal is a laying hen, a broiler chicken, or a weanling pig.

### EXAMPLES

### Example 1

### Nutritional and Metabolic Impacts of a Defatted Green Marine Microalgal (Desmodesmus sp.) Biomass in Diets for Weanling Pigs and Broiler Chickens

Materials and Methods

All animal experimental procedures were approved by the Cornell University Institute Animal Care and Use Committee. The nutrient composition of the DGM is presented in Table 1. Protease RONOZYME® ProAct and NSPase mixture (50% ROXAZYME® G2, 40% RONOZYME® A, and 10% RONOZYME® WX) were obtained from DSM Nutritional Products Inc. (Parsippany, N.J.). Phthaldehyde complete solution reagent was purchased from Sigma-Aldrich (St. Louis, Mo.). Kits for determining uric acid, urea nitrogen, and alanine aminotransferase (ALT) were obtained from Thermo Scientific, Inc. (Waltham, Mass.). Rabbit-anti-β-actin (4967), rabbit-anti-mTOR (7C10), rabbit-anti-phospho-mTOR (S2448), rabbit-anti-S6 (5G10), rabbit-anti-phospho-S6 (S235/236), rabbit-anti-S6K1 (49D7), rabbit-anti-phospho-S6K1 (T389), rabbit-anti-phospho-4E-BP1 (S65), and rabbit-anti-eIF4E (C46H6) monoclonal antibodies were purchased from Cell Signaling Technology, Inc. (Danvers, Mass.).

TABLE 1
Nutritional Composition of DGM (Desmodesmus sp.) Biomass

| Nutrient¹ | % ‘as is’ |
|---|---|
| Dry matter | 96.0 |
| Crude protein | 31.2 |
| Crude fat | 1.50 |
| Acid detergent fiber | 15.4 |
| Neutral detergent fiber | 23.2 |
| Ash | 17.1 |
| Calcium (Ca) | 0.33 |
| Phosphorus (P) | 0.65 |
| Sodium (Na) | 3.24 |
| Potassium (K) | 0.89 |
| Magnesium (Mg) | 0.63 |
| Mineral¹ | mg/kg |
| Iron (Fe) | 1900 |
| Copper (Cu) | 16.0 |
| Manganese (Mn) | 154 |
| Zinc (Zn) | 34.0 |
| Molybdenum (Mo) | 2.40 |
| Selenium (Se) | 0.12 |
| Amino Acid² | % ‘as is’ |
| Alanine | 2.27 |
| Arginine | 1.45 |
| Aspartic acid | 2.69 |
| Cysteine | 0.33 |
| Glutamic acid | 2.93 |
| Glycine | 1.72 |
| Histidine | 0.50 |
| Hydroxylysine | 0.37 |
| Hydroxyproline | 0.07 |
| Isoleucine | 1.10 |
| Leucine | 2.29 |
| Lysine | 1.61 |
| Methionine | 0.48 |
| Ornithine | 0.04 |
| Phenylalanine | 1.34 |
| Proline | 2.73 |
| Serine | 1.10 |
| Taurine | 0.02 |
| Threonine | 1.26 |
| Tryptophan | 0.43 |
| Tyrosine | 1.01 |
| Valine | 1.59 |

¹Samples were analyzed by Dairy One, Inc., Ithaca, NY.
²Samples were analyzed in Experiment Station Chemical Laboratories, University of Missouri, Columbia, MO.

Pig Experiment

Experimental Design, Growth Performance, and Blood Sample Collection

Weanling Yorkshire×Hampshire×Landrace pigs (n=32) were allotted into one of four treatment groups in a 2 (DGM: 0 or 10%, on an ‘as is’ basis)×2 (ProAct: 0 or 0.06%) factorial arrangement (n=8 pigs per treatment). The experimental diet compositions are presented in Table 2. The inclusion rate of ProAct was based on a previous experiment (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety). All diets were formulated to meet the nutrient requirements of weanling pigs (National Research Council, Nutrient Requirements of Swine, Eleventh Revised Edition, The National Academies Press, Washington, D. C., 2012, which is hereby incorporated by reference in its entirety). Pigs were housed in individual pens with a feeder and nipple water drinker. Appropriate feed was weighed out each morning to minimize the amount of spillage. Any spillage was collected and weighed the following morning prior to the addition of fresh feed. Individual pig weights were recorded biweekly for determination of body weight gain and feed conversion efficiency. Blood samples were collected biweekly from the anterior vena cava into heparinized tubes, and kept on ice until analyses were completed on the same day.

TABLE 2
Nutritional Composition of Swine Experimental Diets

| | | Control + | | DGM + |
|---|---|---|---|---|
| Ingredients (%) | Control | Protease | DGM¹ | Protease |
| Corn (yellow) | 64.0 | 64.0 | 62.3 | 62.3 |
| Soybean meal (48.5% CP) | 28.1 | 28.1 | 20.0 | 20.0 |
| DGM | 0.00 | 0.00 | 10.0 | 10.0 |
| Corn oil | 2.00 | 2.00 | 3.00 | 3.00 |
| Dicalcium phosphate | 1.50 | 1.50 | 1.50 | 1.50 |
| Plasma protein | 0.00 | 0.00 | 1.20 | 1.20 |
| Limestone | 0.70 | 0.70 | 0.70 | 0.70 |
| L-Lysine HCl | 0.25 | 0.25 | 0.35 | 0.35 |
| DL-Methionine | 0.01 | 0.01 | 0.01 | 0.01 |
| L-Threonine | 0.10 | 0.10 | 0.10 | 0.10 |
| Salt | 0.18 | 0.18 | 0.00 | 0.00 |
| Vitamin/Mineral mix² | 0.20 | 0.20 | 0.20 | 0.20 |
| Choline | 0.10 | 0.10 | 0.10 | 0.10 |
| Enzyme³ or corn starch | 2.36 | 2.36 | 0.06 | 0.06 |
| Antibiotic⁴ | 0.50 | 0.50 | 0.50 | 0.50 |
| Total | 100.0 | 100.0 | 100.0 | 100.0 |
| Nutritional composition | | | | |
| ME, kcal/kg | 3376 | 3376 | 3373 | 3373 |
| Protein, % | 18.0 | 18.0 | 18.1 | 18.1 |
| Lysine, % | 1.09 | 1.09 | 1.11 | 1.11 |
| Methionine + cysteine, % | 0.64 | 0.64 | 0.64 | 0.64 |
| Threonine, % | 0.70 | 0.70 | 0.65 | 0.65 |

¹DGM: Defatted green microalgal (Desmodesmus sp.) biomass (Cellana, Kailua-Kona, HI) that contained 31.2% crude protein.
²Vitamin and mineral premix supplied the following amounts (per kilogram of diet): vitamin A, 2,200 IU; vitamin D₃, 220 IU; vitamin E, 16 IU; vitamin K, 0.5 mg; biotin, 0.05 mg; choline, 0.5 g; folacin, 0.3 mg; niacin, 15 mg; pantothenic acid, 10 mg; riboflavin, 3.5 mg; thiamin, 1 mg; vitamin B₆, 1.5 mg; vitamin B₁₂, 17.5 μg; Cu, 6 mg; I, 0.14 mg; Mn, 4 mg; Zn 100 mg; Se, 0.3 mg; Mg, 0.4 mg; and Fe, 80 mg.
³RONOZYME ® ProAct (DSM Nutritional Products Inc., Parsippany, NJ). Protease activity was measured in PROT units, where 1 unit is defined as the amount of enzyme that releases 1 μmol of p-nitroaniline from 1 μM of substrate (Suc-Ala-Ala-Pro-Phe-p-nitroaniline) per minute at pH 9.0 and 37° C.
⁴Antibiotic additive (Tylan 10) contained tylosin (as tylosin phosphate) at 22 g/kg.

Plasma Biochemical Analyses

Blood samples were centrifuged at 1500×g for 20 min to collect plasma. Plasma AKP activity was determined according to the method of Bowers and McComb (Wang et al., “The mTOR Pathway in the Control of Protein Synthesis,” Physiol. 21:362-369 (2006), which is hereby incorporated by reference in its entirety). Plasma TRAP activity was determined according to the method of Lau et al., “Characterization and Assay of Tartrate-Resistant Acid Phosphatase Activity in Serum: Potential Use to Assess Bone Resorption,” Clin. Chem. 33:458-462 (1987), which is hereby incorporated by reference in its entirety, with a modification of pH to 5.8. Total plasma amino acid concentration was determined using a modified o-phthaldehyde (OPA) derivatization assay. Briefly, phthaldehyde complete reagent was added at equal volume to a plasma aliquot, vortexed, and read within 2 min at 340 nm on a 96-well plate reader (Biotek Instruments, Inc., Winooski, Vt.). Plasma uric acid, urea nitrogen, and ALT were assayed using the above-described commercial kits.

Apparent Total Tract Digestibility of Amino Acids

All pigs were fed the experimental diets with the inclusion of an indigestible marker (chromium oxide at 0.3%) for a 2-day acclimation period. On the third day, feed and excreta was collected for determining amino acid concentration using the commercial o-phthaldialdehyde (“OPA”) reagent solution followed by spectrophotometric reading at 340 nm (the OPA protocol by Sigma). Apparent total tract digestibility of total amino acids was calculated as (1−[(AAe/AAf)×(Mf/Me)]×100%, where AAe is excreta amino acid concentration, AAf is feed amino acid concentration, Mf is feed marker concentration, and Me is excreta marker concentration (Maynard et al., Animal Nutrition, Sixth Edition, McGraw-Hill Book Company, New York, 1969, which is hereby incorporated by reference in its entirety).

Broiler Experiment

Experimental Design, Growth Performance, and Sample Collection

Ross 308 broiler chicks were received at 1-day of age and assigned to one of six treatment groups in a randomized complete block design. A 2 (DGM: 0 or 15%, on an ‘as is’ basis)×3 (enzyme: none, ProAct, and NSPase) factorial arrangement was used within each block. Each treatment included 5 battery cages (5 birds/cage) and each cage was considered a replicate. The compositions of the control and the DGM-containing diets are shown in Table 3. Both protease and NSPase were incorporated at 0.06% based on previous experiments (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety) and the manufacturer's recommendation. Birds were housed within Petersime battery cages and allowed ad libitum access to feed and water. Birds were fed the starter diet from day 1-21 and the grower diet from day 22-42 (Table 3). All diets were formulated to meet the nutrient requirements for each growth period (National Research Council, Nutrient Requirements of Poultry, Ninth Revised Edition, The National Academies Press, Washington, D. C., 1994, which is hereby incorporated by reference in its entirety). Body weight and feed intake were recorded weekly by cage. Feed spillage was collected and weighed daily. Blood samples (˜1-3 ml, not exceeding 10% of blood volume) were collected at day 21 and day 42 via right wing vein in heparinized needles. At day 42, one bird per cage was euthanized by CO₂ asphyxiation and the liver and right pectoralis muscle were excised and immediately frozen for protein quantitation and Western blot analysis.

TABLE 3
Nutritional Composition of Poultry Experimental Diets

| | Control | DGM¹ | Control | DGM |
|---|---|---|---|---|
| Ingredients (%) | Starter | Starter | Grower | Grower |
| Corn (yellow) | 57.0 | 49.0 | 54.4 | 48.2 |
| Soybean meal (48.5% CP) | 36.9 | 28.0 | 37.0 | 28.2 |
| DGM¹ | 0.00 | 15.0 | 0.00 | 15.0 |
| Corn oil | 1.74 | 3.45 | 4.25 | 5.30 |
| Dicalcium phosphate | 1.95 | 1.19 | 1.95 | 1.19 |
| Limestone | 1.30 | 1.90 | 1.30 | 1.90 |
| L-Lysine HCl | 0.30 | 0.75 | 0.30 | 0.00 |
| DL-Methionine | 0.35 | 0.50 | 0.35 | 0.00 |
| Salt | 0.25 | 0.00 | 0.25 | 0.00 |
| Mineral²/Vitamin³ premix | 0.05 | 0.05 | 0.05 | 0.05 |
| Choline | 0.10 | 0.10 | 0.10 | 0.10 |
| Enzyme⁴ or starch | 0.06 | 0.06 | 0.06 | 0.06 |
| Total | 100.0 | 100.0 | 100.0 | 100.0 |
| Nutritional composition | | | | |
| ME, kcal/kg | 2973 | 3028 | 3100 | 3160 |
| Protein, % | 21.8 | 21.6 | 21.6 | 21.7 |
| Lysine, % | 1.49 | 1.46 | 1.50 | 1.20 |
| Methionine + Cysteine, % | 1.07 | 1.19 | 1.10 | 0.70 |
| Threonine, % | 0.95 | 0.95 | 0.84 | 0.85 |
| Ca, % | 1.05 | 1.07 | 1.10 | 1.10 |
| Available P, % | 0.40 | 0.50 | 0.40 | 0.40 |

¹Defatted green microalgal (Desmodesmus sp.) biomass (Cellana, Kailua-Kona, HI) that contained 31.2% crude protein.
²Provided (in mg/kg of diet): CuSO₄•5H₂O, 31.42; KI, 0.046; FeSO₄•7H₂O, 224.0; MnSO₄•H₂O, 61.54; Na₂SeO₃, 0.13; ZnO, 43.56; Na₂MoO₄•2H₂O, 1.26.
³Provided (in IU/kg of diet): vitamin A, 6500; vitamin D₃, 3500; vitamin E, 25 and (in mg/kg of diet): riboflavin, 25; d-calcium pantothenate, 25; nicotinic acid, 150; cyanocobalamin, 0.011; choline chloride, 1250; biotin, 1.0; folic acid, 2.5; thiamine hydrochloride, 7.0; pyridoxine hydrochloride, 25.0; menadione sodium bisulfite, 5.0; and ethoxyquin, 66.
⁴Each of the four experimental diets contain either starch (control) or protease (RONOZYME ® ProAct, DSM Nutritional Products Inc., Parsippany, NJ) or NSPase (a mixture of 50% ROXAZYME ® G2, 40% RONOZYME ®, and 10% RONOZYME ®WX (DSM Nutritional Products Inc., Parsippany, NJ). Protease activity was measured in PROT units, where 1 unit is defined as the amount of enzyme that releases 1 μmol of p-nitroaniline from 1 μM of substrate (Suc-Ala-Ala-Pro-Phe-p-nitroaniline) per minute at pH 9.0 and 37° C. RONOZYME ® WX activity was measured in FXU units, where the minimum activity of the endo-1,4-β-xylanase is 1,000 FXU/g, where an FXU unit is the amount of enzyme which releases 7.8 μmol of reducing sugar (xylose equivalents) from azo-wheat arabinoxylan per minute at pH 6.0 and 50° C. ROXAZYME ® G2 contains a minimum of 8,000 U/g of endo-1,3-β-glucanase; 18,000 U/g of endo-1,3(4)-β-glucanase; and 26,000 U/g of endo-1,4-β-xylanase. Where 1 U is the amount of enzyme which liberates 0.1 micromoles of glucose from carboxymethylcellulose, barley beta-glucan, or oat spelt xylan per minute at pH 5.0 and 40° C., for each enzyme, respectively. RONOZYME ® A (CT) consisted of 200 kilo-Novo α-amylase units and 350 fungal β-glucanase units/g of enzyme concentrate.

Plasma Biochemical and Western Blot Analyses

Blood samples were centrifuged at 1500×g for 20 min to collect plasma. Total plasma amino acid content and uric acid was assayed using the same methods described above in the pig experiment. Frozen liver and muscle samples were ground in liquid nitrogen. Powdered tissue (10 mg) was then homogenized on ice with ice-cold buffer (80 μl) containing 20 mM 4-(2-hydroxyethyl)-1-piperazineethanesulfonic acid (HEPES), 100 mM KCl, 50 mM NaF, 1 mM dithiothreitol, 0.5 mM sodium orthovanate, 0.2 mM ethylenediaminetetraacetic acid (EDTA), 0.1 mM phenylmethylsulfonyl fluoride (PMSF), and 1 mM benzamidine. Homogenates were centrifuged at 1,000×g for 30 min at 4° C. and the supernatant was centrifuged at 10,000×g for 10 min at 4° C. The final supernatants were aliquoted and stored at −80° C. Tissue lysates (50 μg protein) were subjected to sodium dodecyl sulfate polyacrylamide gel electrophoresis (SDS-PAGE) and western blotting using the appropriate antibodies (Table 4).

TABLE 4
Antibody Information¹

| Antibody | Species | Isotype | Dilution |
|---|---|---|---|
| ²eIF4E | Human | Rabbit | 1,000 |
| ²mTOR | Human | Rabbit | 1,000 |
| ²S6 | Human | Rabbit | 1,000 |
| ²p70 | Human | Rabbit | 1,000 |
| ²pS6 | Human | Rabbit | 2,000 |
| ²β-actin | Human | Rabbit | 3,000 |

¹All antibodies were purchased from Cell Signaling Technology (Beverly, MA).
²eIF4E, eukaryotic initiation factor 4E; mTOR, mammalian target of rapamycin, p70, p70 S6 kinase; S6, S6-ribosomal protein; and pS6, phospho-S6-ribosomal protein.

Statistical Analyses

Data were analyzed with the GLM procedure of PC-SAS 8.1 (SAS Institute, Cary, N.C.). The overall main effects of DGM and the enzymes and their interactions were determined using two-way ANOVA (2 by 2 factorial for the pig experiment and 2 by 3 factorial for the chick experiment). Growth parameters were analyzed as time-repeated measures. Treatment mean comparisons were conducted using the Duncan's multiple range test. If there was an interaction between DGM and the enzyme(s), only conditional (within the same level of the other variable) treatment mean comparisons were considered. Due to the semi-quantitative nature and the limited sample size (n=3) of the Western blot analyses, only selected treatment effects were compared directly with the respective controls using the t-test. Data are expressed as mean±pooled SEM, and P<0.05 was considered statistically significant.

Results

Pig Experiment

Neither the 10% DGM nor the 0.06% protease addition alone affected body weight, average daily gain, average daily feed intake, or feed efficiency at any time points of the 28-day experiment (Table 5). However, there was an interaction between DGM and the enzyme on body weight on day 28 (P=0.03) and overall average body weight gain for the entire 28-day experiment (P=0.02), showing a beneficial trend of the protease to both measures in the presence of DGM, but an adverse effect in the control diet. The DGM inclusion decreased (P=0.05) plasma TRAP activity at day 14, increased (P<0.05) plasma AKP activity at day 28, decreased plasma uric acid concentrations (P=0.07) at day 14, and decreased plasma urea nitrogen concentrations (P<0.05) by 19 and 28% at days 14 and 24, respectively (Table 6). The protease addition decreased (P=0.05) plasma AKP activity at day 14, increased (P<0.05) plasma ALT activity at day 14, and decreased (P<0.05) plasma uric acid concentrations by 24 or 32% at day 14, respectively. While plasma amino acid concentrations were not affected by the two dietary supplements, total tract apparent amino acid digestibility was improved (P<0.05) by 4 and 7% by the protease addition to the control and DGM diets, respectively.

TABLE 5
Effects of DGM and Protease Supplementation on Growth Performance of Pigs¹

| Diet | Control | | DGM | | Pooled | P-value | | |
|---|---|---|---|---|---|---|---|---|
| Enzyme | None | Protease | None | Protease | SEM | DGM | Enzyme | Interaction |

Body weight, kg

| | | | | | | | | |
|---|---|---|---|---|---|---|---|---|
| Day 0 | 9.49 | 9.63 | 9.66 | 9.95 | 0.15 | 0.47 | 0.55 | 0.73 |
| Day 14 | 18.01 | 17.16 | 17.53 | 18.35 | 0.26 | 0.51 | 0.94 | 0.14 |
| Day 28 | 28.60 | 26.23 | 26.67 | 28.09 | 0.45 | 0.96 | 0.60 | 0.03 |

Body weight gain, g/day

| | | | | | | | | |
|---|---|---|---|---|---|---|---|---|
| Day 0-14 | 608.7 | 538.0 | 562.1 | 600.0 | 15.4 | 0.77 | 0.58 | 0.09 |
| Day 14-28 | 756.6 | 647.8 | 647.8 | 695.4 | 18.6 | 0.39 | 0.39 | 0.24 |
| Day 0-28 | 682.7 | 592.9 | 604.9 | 647.7 | 15.0 | 0.71 | 0.40 | 0.02 |

Feed intake, g/day

| | | | | | | | | |
|---|---|---|---|---|---|---|---|---|
| Day 0-14 | 1035.6 | 1022.8 | 934.6 | 1073.5 | 26.7 | 0.58 | 0.22 | 0.17 |
| Day 14-28 | 1218.7 | 1189.1 | 1101.5 | 1138.2 | 33.7 | 0.25 | 0.90 | 0.66 |
| Day 0-28 | 1127.1 | 1106.0 | 1018.0 | 1105.9 | 27.1 | 0.32 | 0.51 | 0.36 |

Gain/feed efficiency

| | | | | | | | | |
|---|---|---|---|---|---|---|---|---|
| Day 0-14 | 0.59 | 0.54 | 0.61 | 0.56 | 0.02 | 0.44 | 0.10 | 1.00 |
| Day 4-28 | 0.62 | 0.55 | 0.60 | 0.61 | 0.02 | 0.52 | 0.34 | 0.17 |
| Day 0-28 | 0.61 | 0.54 | 0.60 | 0.59 | 0.01 | 0.45 | 0.15 | 0.45 |

¹Data are expressed as mean (n = 7-8).

TABLE 6
Effects of DGM and Protease Supplementation on Plasma Biochemical Indicators
and Total Tract Apparent Digestibility of Amino Acids of Pigs¹

| Diet | Control | | DGM | | Pooled | P-value | | |
|---|---|---|---|---|---|---|---|---|
| Enzyme | None | Protease | None | Protease | SEM | DGM | Enzyme | Interaction |

²TRAP, U/L

| | | | | | | | | |
|---|---|---|---|---|---|---|---|---|
| Day 0 | 168.1 | 169.3 | 161.7 | 160.0 | 4.13 | 0.39 | 0.99 | 0.86 |
| Day 14 | 202.5 | 188.7 | 183.3 | 174.6 | 4.22 | 0.05 | 0.92 | 0.47 |
| Day 28 | 144.90 | 144.67 | 145.77 | 144.69 | 0.32 | 0.51 | 0.34 | 0.53 |

³AKP, U/L

| | | | | | | | | |
|---|---|---|---|---|---|---|---|---|
| Day 0 | 87.1 | 86.9 | 86.9 | 82.3 | 1.45 | 0.44 | 0.44 | 0.47 |
| Day 14 | 224.0 | 175.2 | 222.5 | 178.7 | 11.6 | 0.95 | 0.05 | 0.92 |
| Day 28 | 94.5 | 80.0 | 121.9 | 111.2 | 6.88 | 0.03 | 0.36 | 0.66 |

⁴ALT, U/L

| | | | | | | | | |
|---|---|---|---|---|---|---|---|---|
| Day 0 | 16.8 | 14.2 | 13.5 | 15.8 | 0.77 | 0.54 | 0.88 | 0.13 |
| Day 14 | 14.0 | 17.0 | 13.5 | 16.6 | 0.67 | 0.73 | 0.02 | 0.78 |
| Day 28 | 16.0 | 16.1 | 16.9 | 15.0 | 0.68 | 0.89 | 0.60 | 0.54 |

Uric acid, μmol/L

| | | | | | | | | |
|---|---|---|---|---|---|---|---|---|
| Day 0 | 19.2 | 16.8 | 18.2 | 15.3 | 0.67 | 0.40 | 0.06 | 0.70 |
| Day 14 | 30.8^{a} | 23.5^{ab} | 24.5^{ab} | 16.7^{b} | 1.74 | 0.07 | 0.03 | 0.44 |
| Day 28 | 36.0 | 27.5 | 27.0 | 28.3 | 1.01 | 0.38 | 0.62 | 0.22 |

⁵Urea nitrogen, mg/dL

| | | | | | | | | |
|---|---|---|---|---|---|---|---|---|
| Day 0 | 8.3 | 9.9 | 8.8 | 7.5 | 0.40 | 0.27 | 0.80 | 0.07 |
| Day 14 | 5.9 | 7.3 | 5.5 | 5.2 | 0.32 | 0.04 | 0.39 | 0.14 |
| Day 28 | 7.3^{a} | 7.7^{a} | 6.2^{ab} | 4.6^{b} | 0.37 | 0.01 | 0.45 | 0.10 |

Amino acid, μmol/mL

| | | | | | | | | |
|---|---|---|---|---|---|---|---|---|
| Day 0 | 9.7 | 9.6 | 9.7 | 9.7 | 0.15 | 0.91 | 1.00 | 0.82 |
| Day 14 | 17.8 | 17.2 | 17.5 | 17.8 | 0.28 | 0.74 | 0.79 | 0.48 |
| Day 28 | 27.4 | 26.2 | 26.6 | 27.6 | 0.51 | 0.79 | 0.94 | 0.34 |

⁶Apparent total tract amino acid digestibility, %

| | | | | | | | | |
|---|---|---|---|---|---|---|---|---|
| Day 28 | 62.0 | 64.6 | 58.9 | 63.0 | 0.90 | 0.10 | 0.04 | 1.00 |

¹Data are expressed as mean (n = 7-8). Means in the same row without a common superscript letter differ, P < 0.05.
²Tartrate-resistant acid phosphatase.
³Alkaline phosphatase.
⁴Alanine aminotransferase.
⁵Plasma urea nitrogen.
⁶Determined by using chromium oxide as an indicator.

Broiler Experiment

Body weight gains during the grower period (day 22-42) and(or) the entire period (day 0-42) were improved (P<0.05) by the protease addition into the control diet, but decreased (P<0.05) by the NSPase addition to the DGM diet (Table 7). Chicks fed the DGM diet had lower (P<0.05) feed intake than those fed the control diet during the starter period (day 0-21), but this difference was reversed during the grower period, resulting in no difference over the entire 42-day period. Feed efficiency during the starter period or the entire period was greater (P<0.05) in chicks fed the DGM than the control diet without enzyme supplementation. However, both enzyme supplementations to the DGM diets during the starter period or the NSPase addition to the DGM diet and the DGM addition in the presence of NSPase during the grower period and entire period decreased (P<0.05) feed efficiency. Plasma amino acid concentrations were elevated (P<0.05) and decreased (P<0.05) by the addition of the protease into the control diet on days 21 and 42, respectively (Table 8). Plasma uric acid concentrations at day 21 appeared to be decreased by protease, but the only significant difference (P<0.05) was seen between the two enzyme-supplemented DGM diets.

TABLE 7
Effects of DGM and Hydrolytic Enzymes on Growth Performance of Broilers¹

| Diet | Control | | | DGM | | | Pooled | P-value | | |
|---|---|---|---|---|---|---|---|---|---|---|
| Enzyme | None | Protease | NSPase | None | Protease | NSPase | SEM | DGM | Enzyme | Interaction |

Weight gain, g/week/chick

| | | | | | | | | | | |
|---|---|---|---|---|---|---|---|---|---|---|
| Day 0-21 | 221.1 | 235.7 | 227.1 | 221.3 | 238.7 | 216.2 | 3.7 | 0.73 | 0.16 | 0.73 |
| Day 22-42 | 493.0^{b} | 569.3^{a} | 554.1^{ab} | 525.2^{ab} | 539.0^{ab} | 418.5^{b} | 12.2 | 0.02 | 0.01 | 0.01 |
| Day 0-42 | 384.3^{b} | 435.9^{a} | 423.3^{ab} | 403.6^{ab} | 418.8^{ab} | 337.6^{c} | 7.8 | 0.02 | 0.01 | 0.01 |

Feed intake, g/week/chick

| | | | | | | | | | | |
|---|---|---|---|---|---|---|---|---|---|---|
| Day 0-21 | 360.3^{a} | 359.5^{a} | 356.4^{a} | 290.9^{b} | 357.8^{a} | 338.5^{ab} | 7.8 | 0.05 | 0.16 | 0.13 |
| Day 22-42 | 827.5^{b} | 910.3^{ab} | 888.4^{ab} | 1004.0^{a} | 939.3^{ab} | 973.3^{ab} | 21.4 | 0.03 | 0.95 | 0.34 |
| Day 0-42 | 595.9 | 634.9 | 622.4 | 647.4 | 648.5 | 655.9 | 10.4 | 0.13 | 0.68 | 0.75 |

Feed efficiency

| | | | | | | | | | | |
|---|---|---|---|---|---|---|---|---|---|---|
| Day 0-21 | 0.58^{b} | 0.62^{b} | 0.59^{b} | 0.80^{a} | 0.68^{b} | 0.65^{b} | 0.02 | 0.01 | 0.10 | 0.03 |
| Day 22-42 | 0.76^{a} | 0.82^{a} | 0.82^{a} | 0.76^{a} | 0.78^{a} | 0.59^{b} | 0.02 | 0.02 | 0.10 | 0.03 |
| Day 0-42 | 0.67^{bc} | 0.71^{ab} | 0.72^{ab} | 0.78^{a} | 0.73^{ab} | 0.62^{c} | 0.01 | 0.59 | 0.03 | 0.01 |

¹Data are expressed as mean (n = 5). Means in the same row without a common superscript letter differ, P < 0.05.

TABLE 8
Effects of DGM and Hydrolytic Enzymes on Plasma Biochemical Indicators of Broilers¹

| Diet | Control | | | DGM | | | Pooled | P-value | | |
|---|---|---|---|---|---|---|---|---|---|---|
| Enzyme | None | Protease | NSPase | None | Protease | NSPase | SEM | DGM | Enzyme | Interaction |

Plasma amino acids, μmol/mL

| | | | | | | | | | | |
|---|---|---|---|---|---|---|---|---|---|---|
| Day 21 | 0.32^{b} | 0.66^{a} | 0.26^{b} | 0.40^{b} | 0.29^{b} | 0.38^{b} | 0.04 | 0.01 | 0.03 | 0.01 |
| Day 42 | 3.72^{a} | 1.53^{b} | 2.12^{ab} | 2.20^{ab} | 2.36^{ab} | 3.53^{a} | 0.25 | 0.60 | 0.12 | 0.01 |

Plasma uric acid, mmol/L

| | | | | | | | | | | |
|---|---|---|---|---|---|---|---|---|---|---|
| Day 21 | 0.25^{ab} | 0.21^{b} | 0.28^{ab} | 0.27^{ab} | 0.24^{b} | 0.31^{a} | 0.01 | 0.07 | 0.02 | 1.00 |
| Day 42 | 0.51 | 0.57 | 0.52 | 0.54 | 0.48 | 0.53 | 0.01 | 0.68 | 0.98 | 0.08 |

¹Data are expressed as mean (n = 5). Means in the same row without a common superscript letter differ, P < 0.05.

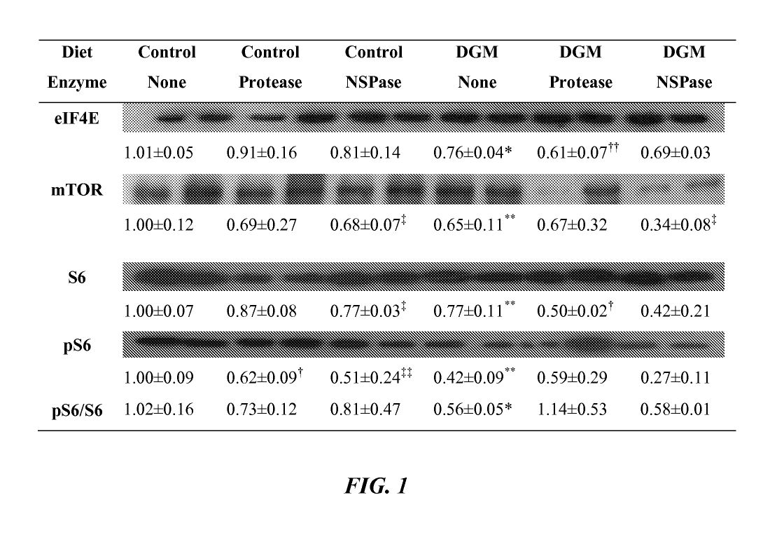

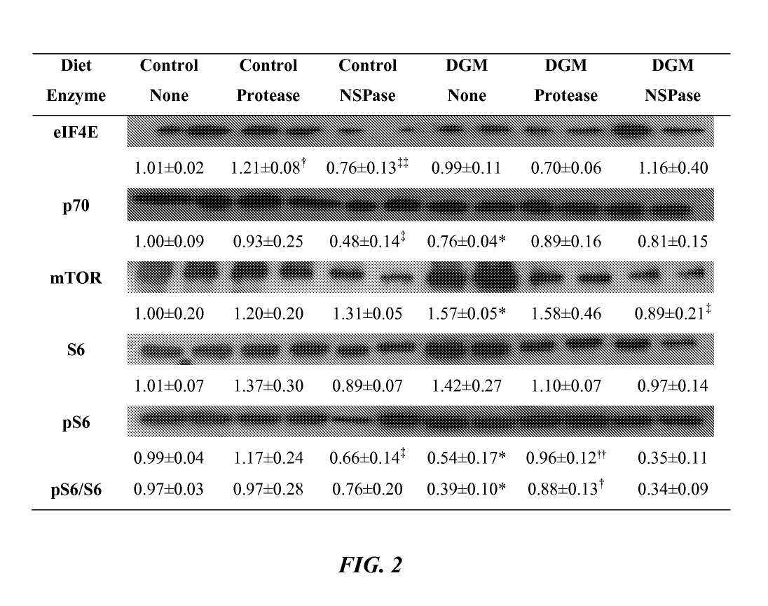

The inclusion of DGM consistently decreased (P<0.05 to 0.1) all four proteins (eIF4E, mTOR, S6, and pS6), and the ratio of pS6/S6 in the liver compared with the control diet without supplemental enzymes (FIG. 1). However, the same inclusion exhibited variable effects on these four proteins, the ratio of pS6/S6, and p70 in the breast muscle (FIG. 2). Supplementing NSPase into the control diet decreased hepatic mTOR (P<0.05), S6 (P<0.05), and pS6 (P<0.1) and muscle eIF4E (P<0.1), p70 (P<0.05), and pS6 (P<0.05), respectively. Supplementing the NSPase into the DGM-containing diet decreased (P<0.05) both hepatic and muscle mTOR levels. Supplementing the protease into the control diet decreased (P<0.05) hepatic pS6 level and elevated (P<0.05) muscle eIF4E level, whereas supplementing the same enzyme into the DGM-containing diet decreased (P<0.05) hepatic eIF4E and S6 levels and enhanced muscle pS6 (P<0.1) and the ratio of pS6/S6 (P<0.05).

Discussion

The pig experiment showed that the 10% inclusion of DGM produced no appreciable adverse effects on growth performance of the pigs except for a 7% decrease in the body weight at day 28 and a 13% decrease in overall daily body weight gain. These decreases were restored by the supplemental protease in the DGM-containing diet. These data are in agreement with past reports that pigs tolerated low levels of various species of microalgal inclusion (Hintz et al., “Sewage-Grown Algae as a Protein Supplement for Swine,” Anim. Prod. 9:135-140 (1967); Isaacs et al., “A Partial Replacement of Soybean Meal by whole or Defatted Algal Meal in Diet for Weanling Pigs Does not Affect their Plasma Biochemical Indicators,” J. of Animal Sci. 89:723-723 (2011); Fevrier et al., “Incorporation of a Spiruline (Spirulina maxima) in Swine Food,” Ann. Nutr. Aliment. 29:625-650 (1975), which are hereby incorporated by reference in their entirety). As shown in previous broiler (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety), hen (Leng et al., “Defatted Algae Biomass may Replace One-Third of Soybean Meal in Diets for Laying Hens,” J. Anim. Sci. 90:701-701 (2012), which is hereby incorporated by reference in its entirety), and pig (Lum et al., “Effects of Various Replacements of Corn and Soy by Defatted Microalgal Meal on Growth Performance and Biochemical Status of Weanling Pigs,” J. Anim. Sci. 90:701-701 (2012), which is hereby incorporated by reference in its entirety) experiments, feeding weanling pigs with the 10% DGM diet in the present study did not alter their plasma ALT activity. Although pigs fed the DGM diet showed elevated plasma AKP activity at day 28, and decreased plasma TRAP activity at day 14, these changes were neither consistent nor sufficient to suggest altered phosphorus nutrition status (Koch et al., “Biological Characteristics for Assessing Low Phosphorus Intake in Finishing Swine,” J. Anim. Sci. 62:163-172 (1986), which is hereby incorporated by reference in its entirety). Previous studies (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety) also supported this notion.

Effects of supplemental DFM and protease on dietary protein digestion and utilization in pigs were assessed by the responses of plasma uric acid, urea nitrogen, and amino acid concentrations as well as apparent total tract digestibility of amino acids. While the DGM diet did not alter plasma amino acid concentration or apparent total tract digestibility of amino acids, it lowered plasma uric acid and urea nitrogen concentrations. These favorable decreases seem to indicate that pigs utilized their ingested nitrogen more efficiently from the DGM-containing diet than the control diet. As plasma urea nitrogen is highly correlated with urinary nitrogen excretion rate (Kohn et al., “Using Blood Urea Nitrogen to Predict Nitrogen Excretion and Efficiency of Nitrogen Utilization in Cattle, Sheep, Goats, Horses, Pigs, and Rats,” J. Anim. Sci. 83:879-889 (2005), which is hereby incorporated by reference in its entirety), its decrease may represent less nitrogen excretion to the environment from the swine production. 1.2% plasma protein was added in the DGM-containing diet to match the protein and amino acid concentrations of the control diet. It is unknown if the superior plasma protein helped overcome any possible deficiencies of the DGM-containing diet. Meanwhile, supplementing 0.06% protease in both control and DGM-containing diets also improved plasma uric acid concentration and total tract apparent digestibility of amino acids. Along with the above-described positive effect on growth performance of pigs, these improvements suggest an enhanced proteolysis by the extrinsic protease in the DGM-containing diet.

Results of the broiler experiment showed a potential of the inclusion of 15% DGM to improve growth performance of chicks. Feed efficiency values of the starter and the entire 42-day periods were higher in chicks fed the DGM-containing diet than those fed the control diet. A decreased feed intake during the starter period followed by an elevated feed intake during the grower period in DGM-fed chicks, compared with those fed the control diet, reflected an adaptation of the animals to the microalgal biomass. Notably, synthetic lysine and methionine were added into the DGM-containing diet only during the starter period. The DGM-containing grower diet was formulated to match only the protein but not the two limiting amino acids of the control diet, which was designed to determine the maximum potential of the DGM as a protein source. Remarkably, chicks fed such grower diet displayed growth performance similar to those fed the control diet. In comparison with the compromised body weight and body weight gain in the weanling pigs fed only 10% DGM, the tolerance of the broiler chicks to the inclusion of 15% DGM without exogenous lysine or methionine implied a better capacity for them to utilize DGM than the weanling pigs.

Supplementing the protease and the NSPase to the broiler diets produced mixed or opposite effects on their growth performance. Protease supplementation to the control diets led to an increased weight gain. However, the same supplementation to the DGM-containing diet, as in the case of 7.5% defatted diatom microalgae supplementation in previous research (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety), showed little or inconsistent effects. Presumably, the DGM contained a high level of NSP within the cell wall structure (Domozych et al., “The Cell Walls of Green Algae: A Journey through Evolution and Diversity,” Front. Plant. Sci. 3:82 (2012), which is hereby incorporated by reference in its entirety). Because NSP possess anti-nutritive activity even at low levels (<50 g/kg) in broiler diets (Annison et al., “Anti-Nutritive Activities of Cereal Non-Starch Polysaccharides in Broiler Diets and Strategies Minimizing their Effects,” World Poult. Sci. J. 47:232-242 (1991), which is hereby incorporated by reference in its entirety), feeding DGM might alter the intestinal transit time, the intestinal mucosa, and hormonal regulations (Vahouny, “Dietary Fiber, Lipid Metabolism, and Atherosclerosis,” Fed. Proc. 41:2801-2806 (1982), which is hereby incorporated by reference in its entirety). Intriguingly, the NSPase supplementation to the DGM-containing diet consistently decreased growth performance. The mechanism responsible for this counter-intuitive response remains unclear. Similar to the results seen at day 14 in the pig experiment, the supplemental protease decreased plasma uric acid concentrations of chicks, suggesting improved dietary nitrogen utilization (Donsbough et al., “Uric Acid, Urea, and Ammonia Concentrations in Serum and Uric Acid Concentration in Excreta as Indicators of Amino Acid Utilization in Diets for Broilers,” Poult. Sci. 89:287-294 (2010); Hernandez et al., “Effect of Low-Protein Diets and Single Sex on Production Performance, Plasma Metabolites, Digestibility, and Nitrogen Excretion in 1- to 48-Day-Old Broilers,” Poult. Sci. 91:683-692 (2012), which are hereby incorporated by reference in their entirety). However, the DGM inclusion, unlike in the case of defatted diatom microalgae (Austic et al., “Potential and Limitation of a New Defatted Diatom Microalgal Biomass in Replacing Soybean Meal and Corn in Diets for Broiler Chickens,” J. Agric. Food Chem. 61(30):7341-7348 (2013), which is hereby incorporated by reference in its entirety), did not decrease plasma uric acid concentration of chicks in the present study. The inclusions of DGM and protease exerted stronger effect on plasma amino acid concentrations at day 21 than day 42. This time difference may again reflect an adaptation of chicks to the microalgal protein over time and(or) less-dependence on exogenous enzymes to hydrolyze dietary proteins at the later stage of growth (Adeola et al., “Board-Invited Review: Opportunities and Challenges in Using Exogenous Enzymes to Improve Nonruminant Animal Production,” J. Anim. Sci. 89:3189-3218 (2011), which is hereby incorporated by reference in its entirety).

It is novel to reveal the strong impacts of the DGM inclusion on the protein production of the five key signal molecules in the pathway of mTOR in both liver and muscle of chicks. Likewise, supplemental protease or NSPase also affected protein levels of these molecules in the two tissues to various extents. Because these proteins are key regulators of cell growth, protein synthesis, and energy metabolism (Annison et al., “Anti-Nutritive Activities of Cereal Non-Starch Polysaccharides in Broiler Diets and Strategies Minimizing their Effects,” World Poult. Sci. J. 47:232-242 (1991), which is hereby incorporated by reference in its entirety), down regulation of them by the inclusions of DGM or enzymes, in particular in liver, were not correlated well with the dietary treatment effects on growth performance or plasma measures unless there was a feedback mechanism at the time-point of the tests.

Overall, weanling pigs and broiler chicks performed well with dietary inclusions of 10 and 15% DGM, respectively. Feeding this biomass decreased plasma uric acid and urea nitrogen concentrations in pigs, and improved feed use efficiency in chicks. Supplemental protease demonstrated moderate benefits to growth performance, total tract apparent digestibility of amino acids, and certain biochemical indicators in pigs and(or) chicks. Supplemental NSPase should help degrade complex carbohydrates in various algal biomass products. DGM and enzymes may be used to improve protein synthesis and metabolism.

### Example 2

### Continual Feeding of Two Types of Microalgal Biomass Affected Protein Metabolism in Laying Hens

Materials and Methods

Animals, Diets, and Care

A total of 150 (26-wk old) Shaver White commercial laying hens were randomly assigned to 5 dietary treatments. There were 5 replicates for each treatment and each replicate consisted of 6 individually-caged hens. The cages (29 cm×47 cm×44.5 cm) were equipped with nipple drinkers and individual trough feeders. Birds were provided a L:D cycle of 16:8 hours. Feed and water were provided for ad libitum consumption throughout the 14 week experimental period. The animal protocol was approved by the Institutional Animal Care and Use Committee (IACUC) at Cornell University.

Defatted green (Desmodesmus sp.) microalgae (DGM) and full-fatted diatom (Staurosira sp.; “FD”) microalgal biomass was generated from a biofuel production research facility (Cellana, Kailua-Kona, Hi.). Initial analyses of the microalgal biomass products were completed to determine their nutrient composition and establish feed formulation values (Dairy One, Cornell University, Ithaca, N.Y.; Agricultural Experiment Station Chemical Laboratories, University of Missouri, Columbia, Mo.; Table 9). The five dietary treatments were a control (Diet 1), and diets comprising 25% DGM (Diets 2 and 3) or 11.7% FD (Diets 4 and 5) without (−) or with (+) a protease enzyme supplement, respectively (Table 10). All diets were formulated to be isocaloric and isonitrogenous based on available information to meet NRC (1994) recommendations for the laying hen. However, to avoid a possible masking of potential negative effects of the algae inclusion by high baseline levels of dietary protein and amino acids, the experimental diets were purposely formulated with 14% crude protein (“CP”) to ensure that hens required all available dietary protein. The protease inclusion rate was at 3 times the manufacturer's recommended level (diets 3 and 5, at 15,000 PROT/kg). Enzyme activity was measured in PROT units, where 1 unit is defined as the amount of enzyme that releases 1 μmol ofp-nitroaniline from 1 μM of substrate (Suc-Ala-Ala-Pro-Phe-p-nitroaniline) per minute at pH 9.0 and 37° C. Each diet was fed to 5 replicates comprised of 6 individually caged birds.

TABLE 9
Approximate Analysis and Amino Acid Profile of the Two Algae Products
Used in the Experiment*

| Item | Green algae | Full-fat Diatom algae |
|---|---|---|
| ME (Mcal/kg) | 2.7 | 1.5 |

%

| | | |
|---|---|---|
| Moisture | 4.0 | 10.3 |
| Crude Protein | 31.2 | 13.9 |
| ADF | 15.4 | 2.3 |
| NDF | 23.2 | 16.0 |
| Crude Fat | 1.5 | 9.3 |
| Ash | 17.1 | 40.0 |
| Calcium | 0.33 | 3.81 |
| Phosphorus | 0.65 | 0.60 |
| Magnesium | 0.63 | 0.71 |
| Potassium | 0.89 | 1.34 |
| Sodium | 3.24 | 3.68 |

mg/kg

| | | |
|---|---|---|
| Iron | 1,900 | 1,230 |
| Zinc | 34 | 16 |
| Copper | 16 | 3 |
| Manganese | 154 | 80 |
| Molybdenum | 2.4 | 1.5 |
| Selenium | 0.12 | <0.1 |

%

| | | |
|---|---|---|
| Aspartic acid | 2.69 | 1.31 |
| Threonine | 1.26 | 0.63 |
| Serine | 1.10 | 0.53 |
| Glutamic acid | 2.93 | 1.29 |
| Proline | 2.73 | 0.45 |
| Glycine | 1.72 | 0.67 |
| Alanine | 2.27 | 0.76 |
| Cysteine | 0.33 | 0.19 |
| Valine | 1.59 | 0.70 |
| Methionine | 0.48 | 0.26 |
| Isoleucine | 1.10 | 0.55 |
| Leucine | 2.29 | 0.94 |
| Tyrosine | 1.01 | 0.40 |
| Lysine | 1.61 | 0.57 |
| Histidine | 0.50 | 0.18 |
| Arginine | 1.45 | 0.61 |
| Tryptophan | 0.43 | 0.12 |

*On as is basis.

TABLE 10
Composition and Nutrient Values of Experimental Diets

| | | | Green | | Diatom |
|---|---|---|---|---|---|
| | | Green | algae + | Diatom | algae + |
| Ingredient, g/kg | Control | algae | Protease | algae | Protease |
| Corn, grain | 638 | 489 | 489 | 517 | 517 |
| Algae | — | 250 | 250 | 117 | 117 |
| Soybean meal 48% | 200 | 50.0 | 50.0 | 184 | 184 |
| Wheat | 30.0 | 59.0 | 59.0 | 31.2 | 31.2 |
| Dicalcium phosphate | 15.6 | 7.10 | 7.10 | 11.7 | 11.7 |
| (min 21% P) | | | | | |
| Limestone | 88.0 | 91.5 | 91.5 | 78.0 | 78.0 |
| Corn oil | 21.0 | 47.5 | 47.5 | 54.5 | 54.5 |
| Lysine-HCl (98.5%) | — | 1.00 | 1.00 | 1.00 | 1.00 |
| Choline (60%) | 1.00 | 1.00 | 1.00 | 1.00 | 1.00 |
| Methionine | 1.10 | 1.70 | 1.70 | 1.70 | 1.70 |
| Sodium chloride | 3.00 | — | — | — | — |
| Vitamin/mineral premix¹ | 3.50 | 3.50 | 3.50 | 3.50 | 3.50 |
| FeSO₄ | 2.20 | — | — | — | — |
| Celite | 0.20 | 0.20 | — | 0.20 | — |
| Protease² | — | — | 0.20 | — | 0.20 |
| Calculated concentration, | | | | | |
| as is basis | | | | | |
| ME, Mj/kg | 11.7 | 11.7 | 11.7 | 11.7 | 11.7 |
| Crude Protein, % | 14.6 | 14.6 | 14.6 | 14.6 | 14.6 |
| Ca, % | 3.70 | 3.60 | 3.70 | 3.70 | 3.70 |
| P, % | 0.59 | 0.50 | 0.50 | 0.55 | 0.55 |
| Cl, % | 0.38 | 0.38 | 0.38 | 0.38 | 0.38 |
| Fe, mg/kg | 64 | 87 | 87 | 56 | 56 |
| Available P, g/kg | 3.4 | 3.4 | 3.4 | 3.4 | 3.4 |
| Lysine, g/kg | 7.9 | 7.9 | 7.9 | 7.9 | 7.9 |
| Methionine, g/kg | 3.6 | 4.2 | 4.2 | 3.9 | 3.9 |
| Met + Cys, g/kg | 6.4 | 6.5 | 6.5 | 6.3 | 6.3 |

¹Premix provided vitamins and minerals at the following levels (per kilogram diet): vitamin A, 6,500 IU; vitamin D, 3,500 IU; vitamin E, 25 IU, menadione bisulfite, 5 mg; riboflavin, 25 mg; d-calcium pantothenic acid, 25 mg; niacin, 150 mg; vitamin B12 (0.1% in mannitol), 11 mg; biotin, 1 mg; folic acid, 2.5 mg; thiamin-HCl, 7 mg; pyridoxine-HCl, 25 mg; CuSO₄•5H₂O, 31.4 mg; KI, 46 μg; MnSO₄•H₂O, 61.5 mg; Na₂SeO₃, 0.13 mg; ZnO, 43.5 mg; Na₂MoO₄•H₂O, 1.3 mg.
²RONOZYME ® ProAct L (DSM, Bagavaerd, Denmark); 75,000 PROT/g. Included at 3X recommended inclusion of 200 mg/kg feed.

Body weights of the laying hens were recorded biweekly. Eggs were collected daily and egg production was calculated on a hen-day basis. Feed intake was recorded biweekly by replicates. Eggs collected on the last 3 days of the 2^{nd}, 4^{th} 6^{th}, 8^{th}, 10^{th}, 12^{th}, and 14^{th} week were individually weighed. The same eggs were then subsequently broken out, the yolk and albumen were separated and weighed, and the egg shell rinsed in distilled water, air dried, and weighed. At the end of the 8th and 14th weeks, one bird per replicate (n=5/treatment) was randomly selected for blood sampling via the right wing vein and euthanized via CO₂ asphyxiation to collect the distal 8 cm of duodenum, jejunum, and ileum, respectively, digesta within the duodenum, jejunum, and ileum, respectively, and liver. Excreta were also collected at week 14.

Total Amino Acid Digestibility

Five days prior to euthanizing at week 14, the same hens described previously were fed the same experimental diets with the inclusion of 0.3% chromium oxide (an indigestible marker) for determination of ileal and excreta total amino acid digestibility (Ravindran et al., “A Comparison of Ileal Digesta and Excreta Analysis for the Determination of Amino Acid Digestibility in Food Ingredients for Poultry,” British Poultry Science 40(2):266-274 (1999); Kim et al., “Interactive Effects of Age, Sex, and Strain on Apparent Ileal Amino Acid Digestibility of Soybean Meal and an Animal By-Product Blend in Broilers,” Poult. Sci. 4:908-917 (2012), which are hereby incorporated by reference in their entirety). Total amino acid in excreta, ileal digesta, and feed, respectively, was determined following the method described by Phthaldialdehyde Reagent Complete Solution (Sigma-Aldrich Co. LLC, St. Louis, Mo.).

Plasma Biochemistry

All chemicals were purchased from Sigma-Aldrich Co., LLC (St. Louis, Mo.) unless otherwise indicated. Blood samples were centrifuged at 1,000×g for 15 min. The plasma fraction was separated and frozen at −20° C. High performance liquid chromatography was used to assay for plasma concentrations of insulin (Sarmento et al., “Development and Validation of a Rapid Reversed-Phase HPLC Method for the Determination of Insulin from Nanoparticulate Systems,” Biomed. Chromatogr. 20:898-903 (2006), which is hereby incorporated by reference in its entirety), 3-methylhistidine (3-MH) (Henrikson et al., “Amino Acid Analysis by Reverse Phase High Performance Liquid Chromatography: Precolumn Derivatization with Phenylthiocyanate,” Anal. Biochem. 136:65-74 (1984), which is hereby incorporated by reference in its entirety), corticosterone (Fowler et al., “The Determination of Plasma Corticosterone of Chickens by High Pressure Liquid Chromatography,” Poult. Sci. 62:1075-1079 (1983), which is hereby incorporated by reference in its entirety), and glutamine (Georgi et al., “High-Performance Liquid Chromatographic Determination of Amino Acids in Protein Hydrosylates and in Plasma Using Automated Pre-Column Derivatization with 0-Phthaldialdehyde/2-Mercaptoethanol,” J. Chromatogr. 613:35-42 (1993), which is hereby incorporated by reference in its entirety). Plasma uric acid concentrations (Miles et al. “Uric Acid Excretion by the Chick as an Indicator of Dietary Protein Quality,” Poult. Sci. 55:98-102 (1976); Vit et al., “Hepatic Purine Enzymes and Uric Acid Excretion as Indicators of Protein Quality in Chicks Fed Graded L-Lysine Diets,” J. Sci. Food Agric. 62:369-374 (1993), which are hereby incorporated by reference in their entirety) were determined using the uric acid liquid stable reagent kit (Infinity™, Fisher Diagnostics, Middletown, N.Y.). Plasma activities of alkaline phosphatase (AKP) were assayed according to the method of Bowers et al., “Measurement of Total Alkaline Phosphatase Activity in Human Serum,” Gun. Chem. 21:1988 (1975), which is hereby incorporated by reference in its entirety. Plasma activities of tartrate-resistant acid phosphatase (TRAP) were determined according to the method of Lau et al., “Characterization and Assay of Tartrate-Resistant Acid Phosphatase Activity in Serum: Potential Use to Assess Bone Resorption,” Clin. Chem. 33:458-462 (1987), which is hereby incorporated by reference in its entirety, with a modification of pH to 5.8.

Protease Activity of Intestinal Digesta and Brush Border and Amino Acid Digestibility

The contents of the small intestines were flushed with ice-cold phosphate buffered saline (PBS) at the duodenum, jejunum, and ileum, respectively, and the contents placed in sterile vials, snap frozen in liquid nitrogen, and stored at −80° C. Upon analysis, intestinal digesta was thawed on ice, homogenized for 60 seconds, and centrifuged at 18,000×g for 20 minutes at 4° C. The supernatant was decanted and used for the protease activity assay. Mucosal fragments were collected from the three segments of small intestines and stored at stored at −80° C. Upon analysis, the mucosal samples were homogenized for 60 seconds and centrifuged for 15 minutes at 3,000×g. The resulting supernatant was centrifuged at 27,000×g for 30 minutes, and the remaining pellet was re-suspended for the protease activity determination. Total protease activity was determined using the azo-casein assay method (Tomarelli et al., “The Use of Azoalbumin as a Substrate in the Colorimetric Determination of Peptic and Tryptic Activity,” J. Lab. Clin. Med. 34:428-433 (1949), which is hereby incorporated by reference in its entirety).

Q-PCR Analysis and Western Blot

To reveal molecular mechanisms for the nutritional and metabolic effects of the microalgal biomass as a new source of feed protein, mRNA and protein responses of several factors in the duodenum and liver was determined. The selection and rationale were as follows: Several of the most important amino acid/peptide transporters include the cationic amino acid transporter (CAT) family, the oligopeptide transporter 1 (PEPT1), and the Na2+-independent branched chain and amino acid transporter (LAT) (Gilbert et al., “Developmental Regulation of Nutrient Transporter and Enzyme mRNA Abundance in the Small Intestine of Broilers,” Poult. Sci. 86:1739-1753 (2007); Gilbert et al., “Dietary Protein Quality and Feed Restriction Influence Abundance Nutrient Transporter mRNA in the Small Intestine of Broiler Chicks,” J. Nutr. 138:262-271 (2008); Speier et al., “Gene Expression of Nutrient Transporters and Digestive Enzymes in the Yolk Sac Membrane and Small Intestine of the Developing Embryonic Chick,” Poult. Sci. 91:1941-1949 (2012); which are hereby incorporated by reference in their entirety). In addition, aminopeptidase (APN) may respond to changes in intestinal protein composition (Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010), which is hereby incorporated by reference in its entirety). As one of the most important functions for dietary protein is to supply amino acids for protein synthesis, it remains to be determined how the algae protein affects tissue protein synthesis. Although there are very complicated systems to control and perform the synthesis, phosphorylation of S6 ribosomal protein (S6) and its up-stream regulators including P70 S6 kinase 1 (P70) and the mammalian target of rapamycin (mTOR), along with the eukaryotic initiation factor 4E (e1F4E) play important roles in the initiating protein synthesis and are responsive to dietary protein changes (Gilbert et al., “Developmental Regulation of Nutrient Transporter and Enzyme mRNA Abundance in the Small Intestine of Broilers,” Poult. Sci. 86:1739-1753 (2007); Gilbert et al., “Dietary Protein Quality and Feed Restriction Influence Abundance Nutrient Transporter mRNA in the Small Intestine of Broiler Chicks,” J. Nutr. 138:262-271 (2008); Speier et al., “Gene Expression of Nutrient Transporters and Digestive Enzymes in the Yolk Sac Membrane and Small Intestine of the Developing Embryonic Chick,” Poult. Sci. 91:1941-1949 (2012); which are hereby incorporated by reference in their entirety).

Tissue samples of the duodenum were homogenized and total RNA was isolated and purified using TRIzol Reagent (Life Technologies, Carlsbad, Calif.). The RNA concentration and quality were determined on a Bio-tek spectrophotometer at an optical density of 260 nm and on an Agilent Bioanalyzer 2100 (Agilent Technologies, Santa Clara, Calif.). The cDNA library was generated using Superscript and random primer/oligo T mixture following the manufacturer's instructions (Life Technologies, Carlsbad, Calif.). To investigate possible impacts of the algae and protease feeding on intestinal protein metabolism, the relative gene expression of the following key factors were determined by RT-qPCR using SYBR Green on an ABI 7700 (Life Technologies, Carlsbad, Calif.): PepT1 (NM_204365.1, which is hereby incorporated by reference in its entirety), LAT-1 (NM_001030579.1, which is hereby incorporated by reference in its entirety), CAT-1 (NM_001145490.1, which is hereby incorporated by reference in its entirety), and APN (NM_204861.1, which is hereby incorporated by reference in its entirety). The primers used for each individual gene are presented in Table 11. The relative gene expression for each sample was adjusted with the expression of control gene, β-actin (NM_205518.1, which is hereby incorporated by reference in its entirety), using the AACt equation (Livak et al., “Analysis of Relative Gene Expression Data Using Real-Time Quantitative PCR and the 2[-delta delta C(T)] Method,” Methods 25:402-408 (2001), which is hereby incorporated by reference in its entirety) and normalized to the control hens.

TABLE 11
Primer Sequences for Chicken mRNA

| | | | Melting |
|---|---|---|---|
| | Direc- | | Temp |
| Gene | tion | Sequence | (° C.) |
| Apn | Forward | 5′-ACCTCATCCTGATCCACAGCAACA | 65.85 |
| | | (SEQ ID NO: 1) | |
| | Reverse | 5′-TGAAGATGCTGAAGAGGCGGTAGT | 64.25 |
| | | (SEQ ID NO: 2) | |
| Cat11 | Forward | 5′-CCGGCTCTCACGGTGCCTCA | 69.92 |
| | | (SEQ ID NO: 3) | |
| | Reverse | 5′-TGCCACAGCCCCAGCCAGTA | 67.96 |
| | | (SEQ ID NO: 4) | |
| Lat1 | Forward | 5′-TACAGTGTGAAAGCTGCTACCCGT | 60.2 |
| | | (SEQ ID NO: 5) | |
| | Reverse | 5′-CGCAACGTTAGACTTGCTTCGGTT | 60.3 |
| | | (SEQ ID NO: 6) | |
| Pept1 | Forward | 5′-AGCTATGCAGATTCAGCCAGACCA | 65.11 |
| | | (SEQ ID NO: 7) | |
| | Reverse | 5′-ACATGCCAACAGTGATCCTCCTCA | 65.85 |
| | | (SEQ ID NO: 8) | |
| βAct | Forward | 5′ AGACATCAGGGTGTGATGGTTGT | 61.42 |
| | | (SEQ ID NO: 9) | |
| | Reverse | 5′-TCCCAGTTGGTGACAATACCGTGT | 65.34 |
| | | (SEQ ID NO: 10) | |

Apn, aminopeptidase N; Cat1, cationic amino acid transporter-1; Lat1, L-type amino acid transporter-1; Pept1, peptide transporter-1; and βAact, β-actin.

The information on the primary antibodies used in the present study is presented Table 12. Goat anti rabbit IgG horseradish peroxidase conjugate was from Bio-Rad Laboratories, Inc. (Hercules, Calif.). Signal detection used a chemiluminescent substrate from Thermo Fisher Scientific, Inc. (Rockford, Ill.). Hen liver samples (6-10 mg) were extracted by cryopulverization using a liquid nitrogen cooled mortar and pestle. The extracts were dissolved in protein lysis buffer (150 mM sodium chloride; 10 mM Tris amino methane; 1 mM EDTA; 1 mM ethylene glycol-bis-N,N,N′,N′-tetraacetic acid; 1% triton; 0.5% NP-40; 100 mM sodium fluoride; 10 mM sodium phosphate; and 2 mM sodium orthovanadate). The homogenates were left on ice for 45 minutes, and then centrifuged for 30 minutes at 1,000 g at 4° C. The supernatants were centrifuged again at 10,000 g for 45 minutes and subjected to a final centrifugation at 150,000 g for 45 minutes. The protein contents of the resulting supernatants were determined by bicinchoninic acid (BCA) assay (Thermo Fisher Scientific, Rockford, Ill.).

TABLE 12
Name, Type, and Dilution of Primary Antibodies Used for Western
Analyses of Protein Synthesis-related Factors in the Liver of Laying
Hens Fed Two Types of Microalgae*

| Antibody | Species | Isotype | Dilution Factor |
|---|---|---|---|
| eIF4E** | Human | Rabbit | 1,000 |
| mTOR | Human | Rabbit | 1,000 |
| p70 | Human | Rabbit | 1,000 |
| S6 | Human | Rabbit | 1,000 |
| PS6 | Human | Rabbit | 2,000 |

*All antibodies were purchased from Cell Signaling Technology (Beverly, MA).
**eIF4E, eukaryotic initiation factor 4E; mTOR, mammalian target of rapamycin; p70, p70 S6 kinase; S6, S6-ribosomal protein; and PS6, phospho-S6-ribosomal protein.

Liver homogenates (25 μg protein) were dissolved in SDS reducing sample buffer and boiled for 5 minutes before loading onto 12% (7.5% for the detection mTOR which has a large molecular weight) SDS-PAGE reducing mini-gels (Bio-Rad Laboratories Inc., Hercules, Calif.). Gels were run at a constant 30 mA. Proteins in the gels were transferred onto nitrocellulose membranes using a BioRad mini-trans blot cell at 100 volts for 60 min (75 minutes for mTOR). Membranes were blocked in 5% milk in Tris buffered saline containing 0.1% tween-20 (TBST) for 1 hour at room temperature (RT) on a rocking platform. After three 5 minute washes with TBST, membranes were incubated with rabbit primary antibodies (Cell Signaling Technology, Inc., Danvers, Mass.) overnight at 4° C. with constant gentle agitation. Antibodies were diluted 1:1000 in 3% BSA TWEEN®20 (TBST) buffer for p70 S6 kinase, S6, phospho-S6, and eIF4E, and in 3% milk TBST for mammalian target of rapamycin (mTOR). Membranes were washed three times in TBST before incubating for 1 hour at RT with the goat anti rabbit IgG horseradish peroxidase conjugate (Bio-Rad Laboratories Inc., Hercules, Calif.) diluted 1:3000 in 3% milk TBST. After three washes in TBST and five rinses in distilled water, membranes were incubated for 5 minutes at RT in SuperSignal West Pico chemiluminescent substrate (Pierce, Rockford, Ill.) before exposing to Kodak BioMax XAR film (Carestream, Rochester, N.Y.). The relative quantification of the target protein band was determined as previously described (Yan et al., “Dietary Selenium Deficiency Partially Rescues Type 2 Diabetes-Like Phenotypes of Glutathione Peroxidase-1-Overexpressing Male Mice,” J. Nutr. 142:1975-1982 (2012), which is hereby incorporated by reference in its entirety).

Statistical Analysis

A randomized complete block design was used with 5 replicates per treatment and 6 birds per replicate. Five orthogonal contrasts were performed to determine differences between the algae-based diets and the control diet, between algae diets, and between enzyme treatments using JMP 8.0 (SAS Institute, Cary, N.C.).

1. Control vs. DGM⁻+FD⁻ (1 vs. 2+4)

2. DGM⁻ vs. FD⁻ (2 vs. 4)

3. DGM⁺ vs. DG⁻ (2 vs. 3)

4. FD⁺ vs. FD⁻ (4 vs. 5)

5. DGM⁺+FD⁺ vs. DGM⁻+FD⁻ (2+4 vs. 3+5)

Significance was defined as P<0.05.

Results

Egg Production and Quality

The body weight (BW), average daily feed intake (ADFI), hen-day egg production, and shell weight were not influenced by dietary treatments (Table 13). The feed intake was decreased (P<0.05) by feeding the two types of algal biomass during the initial 2 weeks. Average egg and albumen weight were decreased (P<0.05) by feeding the green microalgae as compared with diatom algae. Average yolk weight was also higher in diets containing protease, specifically green algae (Table 13).

TABLE 13
Effect of Dietary Algae Inclusion With and Without Protease Supplementation on Egg Production and Quality of Layer Hens¹

| | | Green | Green algae + | Diatom | Diatom algae + | | | | | | 2, 4 vs. |
|---|---|---|---|---|---|---|---|---|---|---|---|
| | Control | algae | protease | algae | protease | SEM | 1 vs. 2, 4 | 2 vs. 4 | 2 vs. 3 | 4 vs. 5 | 3, 5 |
| Initial body wt, g | 1530 | 1555 | 1543 | 1544 | 1548 | 18 | 0.43 | 0.70 | 0.67 | 0.88 | 0.84 |
| Final body wt, g | 1395 | 1433 | 1442 | 1484 | 1479 | 20.1 | 0.10 | 0.25 | 0.85 | 0.92 | 0.95 |
| Feed intake, g/d | 99.6 | 81.2 | 96.2 | 83.2 | 81.7 | 10.9 | | | | | |
| Hen-day egg | 88.9 | 84.7 | 85.3 | 88.4 | 90.6 | 2 | 0.35 | 0.43 | 0.65 | 0.37 | 0.75 |
| production, % | | | | | | | | | | | |
| Egg wt, g | 54.5 | 52 | 53.2 | 55.2 | 55.4 | 0.64 | 0.10 | <0.001 | 0.10 | 0.73 | 0.15 |
| Yolk wt, g | 14.9 | 14.7 | 15.1 | 14.7 | 14.9 | 0.16 | 0.37 | 0.76 | 0.04 | 0.42 | 0.04 |
| Albumen wt, g | 32.8 | 30.7 | 30.8 | 33.2 | 33.6 | 0.43 | 0.13 | <0.001 | 0.97 | 0.86 | 0.93 |
| Shell wt, g | 5.4 | 5.4 | 5.4 | 5.6 | 5.6 | 0.08 | 0.85 | 0.98 | 0.21 | 0.11 | 0.04 |

¹Values are expressed as means (n = 5/treatment) of biweekly data over the whole period.

Plasma Biochemical Indicators

There were no significant differences among the 5 treatment groups in plasma concentrations of insulin, glutamine, uric acid, and AKP at either week 8 or 14 (Table 14). Plasma 3-MH concentrations were statistically higher in hens fed the control diet as compared with algae diets at week 14. Corticosterone concentrations were found to be lower in hens fed diatom algae with protease as compared with hens fed diatom algae without protease at week 14. Plasma TRAP activities were lower (P<0.05) in the green algae-fed group at week 8 and in all algae-fed groups at week 14 than those of the control.

TABLE 14
Effect of Dietary Algae Inclusion With or Without Protease Supplementation
on Plasma Biochemistry of Laying Hens at Week 8 and 14^{1,2}

| | | | | | | Diatom | | | | | | |
|---|---|---|---|---|---|---|---|---|---|---|---|---|
| | | | Green | Green algae + | Diatom | algae + | | | | | | 2, 4 vs. |
| | Week | Control | algae | protease | algae | protease | SEM | 1 vs. 2, 4 | 2 vs. 4 | 2 vs. 3 | 4 vs. 5 | 3, 5 |
| 3-MH², mol/L | 8 | 23.3 | 21.6 | 22.9 | 20.5 | 20.8 | 3.1 | 0.51 | 0.78 | 0.73 | 0.95 | 0.79 |
| | 14 | 32.2 | 23.8 | 23 | 23 | 21.9 | 2.6 | 0.03 | 0.85 | 0.84 | 0.83 | 0.76 |
| Glutamine | 8 | 9.5 | 5.9 | 8.3 | 4.5 | 5 | 2.9 | 0.10 | 0.72 | 0.47 | 0.26 | 0.20 |
| (nmol/L) | 14 | 3.3 | 3 | 3.6 | 4.8 | 3.2 | 1.2 | 0.68 | 0.29 | 0.72 | 0.37 | 0.65 |
| Uric acid, U/L | 8 | 13.7 | 9.8 | 11.2 | 13.1 | 17.1 | 2.4 | 0.45 | 0.35 | 0.68 | 0.25 | 0.27 |
| | 14 | 12 | 8.8 | 8.4 | 8.6 | 7 | 1.9 | 0.19 | 0.93 | 0.89 | 0.57 | 0.61 |
| Corticosterone | 8 | 0.14 | 0.26 | 0.21 | 0.1 | 0.29 | 0.09 | 0.75 | 0.22 | 0.71 | 0.24 | 0.53 |
| (μg/L) | 14 | 0.25 | 0.22 | 0.26 | 0.39 | 0.17 | 0.07 | 0.42 | 0.09 | 0.66 | 0.04 | 0.18 |
| Insulin | 8 | 0.65 | 0.53 | 0.83 | 0.51 | 0.7 | 0.18 | 0.97 | 0.69 | 0.70 | 0.62 | 0.55 |
| (mmol/L) | 14 | 1.4 | 1.7 | 1.6 | 1.6 | 1.3 | 0.19 | 0.36 | 0.74 | 0.87 | 0.45 | 0.50 |
| TRAP, U/L | 8 | 22.8 | 17.3 | 29.1 | 33.6 | 24.2 | 2.9 | 0.47 | 0.001 | 0.01 | 0.04 | 0.69 |
| | 14 | 41.1 | 18.2 | 25.1 | 22.8 | 24.9 | 2.9 | <0.001 | 0.32 | 0.12 | 0.67 | 0.18 |
| AKP, U/L | 8 | 13.8 | 13.3 | 11.2 | 12.2 | 14.7 | 1.5 | 0.58 | 0.62 | 0.35 | 0.25 | 0.88 |
| | 14 | 13.3 | 13.2 | 11.9 | 12.5 | 12 | 0.89 | 0.68 | 0.54 | 0.25 | 0.71 | 0.30 |

¹Values are expressed as means (n = 5/treatment).
²3-MH, 3-methylhistidine; TRAP, tartrate resistant-resistant acid phosphatase; and AKP, alkaline phosphatase.

Protease Activities of Digesta and Brush Border and Amino Acid Digestibility

No statistically significant differences were determined for duodenal, jejuna, or ileal protease activity in the digesta of laying hens (Table 15). Hens fed the green and diatom algae had greater (P<0.05) protease activity in jejunal brush border at week 14 than the control (Table 15). The addition of protease increased the brush border protease activity at the duodenum at week 14. No other changes to brush border activity were determined.

TABLE 15
Effect of Dietary Algae Inclusion With or Without Protease Supplementation on Protease Activity of Digesta and Brush Border
Membrane of Different Small Intestinal Segments and Heal and Excreta Apparent Amino Acid Digestibility at Week 8 and 14¹

| | | Green | Green algae + | Diatom | Diatom algae + | | | | | | 2, 4 vs. |
|---|---|---|---|---|---|---|---|---|---|---|---|
| Week | Control | algae | protease | algae | protease | SEM | 1 vs. 2, 4 | 2 vs. 4 | 2 vs. 3 | 4 vs. 5 | 3, 5 |

Digesta, mU/mg digesta (as is)

| | | | | | | | | | | | | |
|---|---|---|---|---|---|---|---|---|---|---|---|---|
| Duodenum | 8 | 317 | 458.4 | 374.9 | 338.6 | 491.1 | 75 | 0.65 | 0.44 | 0.92 | 0.11 | 0.23 |
| | 14 | 207.2 | 217.1 | 283.5 | 257.6 | 384.7 | 64.5 | 0.71 | 0.66 | 0.48 | 0.18 | 0.15 |
| Jejunum | 8 | 314.7 | 285 | 253.1 | 348.8 | 321.7 | 60.4 | 0.30 | 0.69 | 0.84 | 0.39 | 0.64 |
| | 14 | 213.8 | 325.8 | 248.7 | 212.0 | 205.4 | 23.6 | 0.08 | 0.00 | 0.04 | 0.85 | 0.10 |
| Ileum | 8 | 262.2 | 265.9 | 395.1 | 362.5 | 268.3 | 45.5 | 0.31 | 0.09 | 0.83 | 0.09 | 0.28 |
| | 14 | 281.5 | 279.3 | 276.6 | 279.8 | 286.1 | 9.3 | 0.86 | 0.97 | 0.84 | 0.64 | 0.85 |

Brush border membrane, mU/mg wet tissue

| | | | | | | | | | | | | |
|---|---|---|---|---|---|---|---|---|---|---|---|---|
| Duodenum | 8 | 241.1 | 231.3 | 231.6 | 213.4 | 231.6 | 8.6 | 0.13 | 0.20 | 0.98 | 0.19 | 0.33 |
| | 14 | 230.2 | 226.4 | 231 | 227.4 | 230.2 | 1 | 0.04 | 0.49 | 0.02 | 0.10 | 0.01 |
| Jejunum | 8 | 244.6 | 253 | 258.6 | 255.4 | 252 | 3.6 | 0.08 | 0.65 | 0.32 | 0.52 | 0.78 |
| | 14 | 233.4 | 239 | 240.8 | 241.4 | 239.4 | 2 | 0.04 | 0.43 | 0.56 | 0.49 | 0.93 |
| Ileum | 8 | 47.9 | 42 | 42 | 43.4 | 36.7 | 2.4 | 0.61 | 0.90 | 1.00 | 0.09 | 0.19 |
| | 14 | 71 | 48.2 | 39.8 | 62.6 | 41.6 | 8.3 | 0.19 | 0.28 | 0.51 | 0.23 | 0.20 |

Amino Acid Digestibility² (%)

| | | | | | | | | | | | | |
|---|---|---|---|---|---|---|---|---|---|---|---|---|
| Excreta | 14 | 73.0 | 76.4 | 76.7 | 75.5 | 78.6 | 2.3 | 0.34 | 0.80 | 0.92 | 0.39 | 0.49 |
| Ileum | | 82.4 | 90.6 | 89.1 | 88.0 | 86.9 | 0.6 | 0.002 | 0.04 | 0.14 | 0.23 | 0.08 |

¹Values are expressed as means (n = 5/treatment).
²Measured at week 14 using Cr₂O₃ as an indigestible marker.

Expression of Genes and Proteins Related to Protein Metabolism

A significant main effect was observed for LAT1. Compared with the control, hens fed the green algae and diatom algae with protease had lower (P<0.05) mRNA levels of LAT1, respectively, in the duodenum at week 14 (Table 16). Orthogonal contrasts also revealed that algae-containing diets had lower levels of LAT1 than the control diet. No other main effects were determined for CAT1, PepT1, or APN. However, the orthogonal contrast results of APN suggest lower APN levels in algae-containing diets (P=0.056).

TABLE 16
Effect of Dietary Algae Inclusion With or Without Protease
Supplementation on Relative mRNA Levels of Amino Acid and
Peptide Transporters in the Duodenum at Week 14¹

| | | Green | Green algae + | Diatom | Diatom + | |
|---|---|---|---|---|---|---|
| Gene | Control | algae | protease | algae | protease | SEM |
| Apn² | 1.00 | 0.52 | 0.82 | 0.72 | 0.24 | 0.10 |
| Cat1 | 1.00 | 0.76 | 1.43 | 1.57 | 0.80 | 0.18 |
| Lat1 | 1.00^{a} | 0.29^{b} | 0.49^{ab} | 0.61^{ab} | 0.42^{b} | 0.07 |
| Pept1 | 1.00 | 1.43 | 1.92 | 0.12 | 1.25 | 0.29 |

¹Data are expressed as mean of the relative changes compared to the control (n = 3-4).
²Apn, aminopeptidase N; Cat1, cationic amino acid transporter-1; Lat1, L-type amino acid transporter-1; and Pept1, peptide transporter-1.
Values without a common superscript letter differ, P < 0.05.

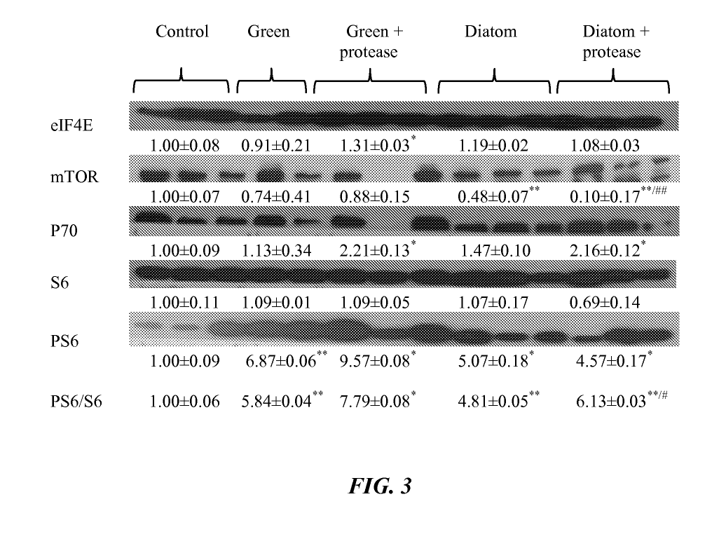

The amounts of hepatic phosphor-S6 (PS6) and the ratios of PS6/S6 were elevated by 4-9 fold (P<0.05) in the 4 algae-fed groups compared with the control (FIG. 3), whereas the hepatic S6 protein amounts were not affected by the dietary treatments. Compared with the control, the hens fed the green algae plus protease had greater (P<0.05) levels of hepatic e1F4E and P70. The two groups of hens fed the diatom algae had lower (P<0.05) hepatic mTOR levels, but higher levels of hepatic P70 than the control.

Discussion

The present study showed that feeding hens with 25% of the defatted green microalgae or 11.7% of the full-fatted diatom microalgae for 14 weeks did not decrease overall egg production, feed intake, or body weight. Meanwhile, hens fed these algal products had plasma concentrations of insulin, glutamine, uric acid, and AKP activities similar to those of the controls at the two time-points tested. Plasma TRAP activities in the algae-fed hens were lower than those of the controls, suggesting a better bone and(or) phosphorus status (Igarashi et al., “Acid Phosphatases as Marker of Bone Metabolism,” J. Chromatogr. B Analyt. Technol. Biomed. Life Sci. 781:345-358 (2002); Ekmay et al., “The Effects of Pullet Body Weight, Dietary Nonpyhtate Phosphorus Intake, and Breeder Feeding Regimen on Production Performance, Chick Quality, and Bone Remodeling in Broiler Breeders,” Poult. Sci. 91:948-64 (2012); which are hereby incorporated by reference in their entirety). Thus, both sources of microalgal biomass supported egg production and physiological maintenance when they were incorporated at the designated rates on an isocaloric and isonitrogenous bases compared with the corn-soybean meal-wheat control diet.

In an earlier study (Leng et al., “Defatted Algae Biomass may Replace One-Third of Soybean Meal in Diets for Laying Hens,” J. Anim. Sci. 90(Supp1.3):701 (2012), which is hereby incorporated by reference in its entirety), it was observed that Shaver laying hens fed with the defatted diatom algae for 8 weeks decreased feed intake and egg production in hens fed 15% but not 7.5% compared with the controls. Similarly, hens fed the two sources of algae had lower feed intakes and egg production in the initial 2-3 weeks of the present study. The initial depression in performance may be due to indigestible cell wall components (polysaccharides, algaenans) or mineral (ash) content. However, those differences disappeared thereafter, which suggests that the hens were able to acclimate to the algae feeding.

Long-term studies such as those by Lipstein et al., “The Nutritional Value of Algae for Poultry. Dried Chlorella in Layer Diets,” Br. Poultry Sci. 21:23-27 (1980), which is hereby incorporated by reference in its entirety, and El-Deek et al., “The Use of Brown Algae Meal in Finisher Broiler Diets,” Egypt. Poult. Sci. 31:767-781 (2011), which is hereby incorporated by reference in its entirety, successfully incorporated algae at levels above 10%, whereas short-term studies such as those by Ginzberg et al., “Chickens Fed with Biomass of the Red Microalga Porphyridium sp. Have Reduced Blood Cholesterol Level and Modified Fatty Acid Composition in Egg Yolk,” J. Appl. Phycol. 12:325-330 (2000), which is hereby incorporated by reference in its entirety, and Lipstein et al., “The Nutritive Value of Sewage-Grown, Alum-Flocculated Micractinium Algae in Broiler and Laying Diets,” Poult. Sci. 60:2628-2638 (1981), which is hereby incorporated by reference in its entirety, showed a depression in laying hen and broiler performance. Thus, the extended feeding time in the present study allowed for a greater ability to demonstrate the potential for feeding the hens with these algal products. Moreover, this study extends the previous research on the diatom microalgae to a new source of green algae. With 31% crude protein, green algae could be incorporated at a much greater level (25%) than the diatom, with only moderately adverse effect on the egg and egg albumen weights. The prevailing thought has been that algae can only be included in the diet at up to 10% (Becker, “Microalgae in Human and Animal Nutrition,” Richmond A., ed., Handbook of Microalgae Culture, Biotechnology and Applied Phycology, Oxford: Blackwell Science, p. 312-351 (2004), which is hereby incorporated by reference in its entirety). However, results from the present study suggest that greater levels of incorporation are possible given sufficient acclimation time.

In the present study, hens fed the algae diets had lower concentrations of plasma 3-MH than those fed the control diet. As a biomarker of protein degradation (Young et al., “Ntau-Methylhistidine (3-Methylhistidine) and Muscle Protein Turnover: An Overview,” Fed. Proc. 37:2291-300 (1978), which is hereby incorporated by reference in its entirety), the lower plasma 3-MH would suggest less mobilization of muscle tissue to meet the protein requirements of the hens. Ileal total amino acid digestibility was greater in the hens fed the algae-containing diets than those fed the control diet. Ileal digestibility was higher in hens fed green algae as compared with hens fed diatom algae, as well. Furthermore, total protease activities were greater in jejunal brush border activity of hens fed algae than control hens, and in the brush border membrane of duodenum of hens fed green algae+protease.

Seemingly, the algae-containing diets had better protein values or greater amino acid bioavailability than the control diet. This result is contrary to the current perception of algae protein digestibility or biological value in comparison with those of casein, egg, and soybean (Tejada de Hernandez et al., “Nutritive Value of the Spirulina Algae (Spirulina maxima),” Arch. Latinoam. Nutr. 28:196-207 (1978); Becker, “Micro-Algae as a Source of Protein,” Biotechnol. Adv. 25:207-210 (2007); Misurcova et al., “Nitrogen Content, Dietary Fiber, and Digestibility in Algal Food Products,” Czech J. Food Sci. 28:27-35 (2010); Skrede et al., “Evaluation of Microalgae as Sources of Digestible Nutrients for Monogastric Animals,” J. Anim. Feed Sci. 20:131-142 (2011); which are hereby incorporated by reference in their entirety). However, direct comparisons of biological value between algae and soybean are not well established. It has been shown that intestinal peptidase activity adapts to changes in dietary protein intake and quality (Corring, “The Adaptation of Digestive Enzyme to the Diet: Its Physiological Significance,” Reprod. Nutr. Develop. 20:1217-1235 (1980), which is hereby incorporated by reference in its entirety). As all diets in the present study were formulated to be isonitrogenous, elevated intestinal brush border membrane proteolytic activity in the algae-fed hens was likely associated with protein quality differences (Gilbert et al., “Dietary Protein Quality and Feed Restriction Influence Abundance Nutrient Transporter mRNA in the Small Intestine of Broiler Chicks,” J. Nutr. 138:262-271 (2008); Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010); which are hereby incorporated by reference in their entirety), including protein types and amino acid profile or balance (Smith et al., “The Combined Amino Acids in Several Species of Marine Algae,” J. Bio. Chem. 217:845-854 (1955); Lewis et al., “Amino Acid Contents of Some Marine Algae from Bombay,” New Phytologist 59:109-115 (1960); Punnett et al., “The Amino Acid Composition of Algal Cell Walls,” J. Gen. Micrbiol. 44:105-114 (1966); Boyd, “Amino Acid Composition of Freshwater Algae,” Arch. Hydrobiol. 72:1-9 (1973); Campanella et al., “Free and Total Amino Acid Composition in Blue-Green Algae,” Ann. Chim. 92:343-52 (2002); which are hereby incorporated by reference in their entirety).

Elevated dietary fiber levels were also considered as an explanation for the observed changes to intestinal protease activity. High dietary fiber diets up-regulated intestinal proteolytic activity in the small intestine of weanling pigs (Hedemann et al., “Intestinal Morphology and Enzymatic Activity in Newly Weaned Pigs Fed Contrasting Fiber Concentrations and Fiber Properties,” J. Anim. Sci. 84:1375-1386 (2006); which is hereby incorporated by reference in its entirety). Also, Farness et al., “Effects of Dietary Cellulose, Pectin and Oat Bran on the Small Intestine in the Rat,” J. Nut. 112:1315-1319 (1982), which is hereby incorporated by reference in its entirety, reported an increased peptidase activity in the small intestine of rats fed high levels of pectin or cellulose. However, only the high level of fiber (ADF=15.4%) in the diatom algae, but not in the green algae (ADF=2%), may help explain in part the observed increase in intestinal protease activity. Aumaitre et al., “Non-Starch Polysaccharides of Sugar-Beet Pulp Improve the Adaptation to the Starter Diet, Growth and Digestive Process of the Weaned Pig,” Brufau J. (ed.), Feed Manufacturing in the Mediterranean Region. Improving safety: From Feed to Food, Zaragoza: CIHEAM, p. 185-189 (2001), which is hereby incorporated by reference in its entirety, found that the inclusion of non-starch polysaccharide from beet pulp in the diet of weanling pigs elevated peptidase activity in their intestines, with improved growth performance and carcass composition. It is unclear if certain types of polysaccharides or compounds in the algae products, and specifically the cell wall, enhanced intestinal proteolytic activity and ileal amino acid digestibility in the hens. The composition of the cell wall may also explain the lack of an observed effect to protease inclusion.

The inclusion of dietary algae appeared to enhance protein metabolism based on biochemical markers and intestinal protease activity, however the inclusion of algae and protease exerted mixed impacts on gene expressions of three amino acid and peptide transporters and aminopeptidase N (APN) in the duodenum of hens at week 14. While Gilbert et al., “Developmental Regulation of Nutrient Transporter and Enzyme mRNA Abundance in the Small Intestine of Broilers,” Poult. Sci. 86:1739-1753 (2007), which is hereby incorporated by reference in its entirety, found increased expression of PepT1 due to higher quality protein, the present study did not show any such change. The two types of algae seemed to decrease the gene expression of LAT1 and APN, although Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010), which is hereby incorporated by reference in its entirety, did not show such changes due to protein composition. The lack of change to duodenal digesta and brush border membrane protease activity despite lower expression of APN suggests a greater efficiency is achieved.

Expression of CAT1 in the jejunum was decreased in growing pigs fed a wheat-based diet supplemented with lysine, threonine, and methionine (Garcia-Villalobos et al., “Effects of Dietary Protein and Amino Acid Levels on the Expression of Selected Cationic Amino Acid Transporters and Serum Amino Acid Concentration in Growing Pigs,” Arch. Anim. Nutr. 66:257-270 (2012), which is hereby incorporated by reference in its entirety). However, no changes were observed to CAT1 expression across treatment groups. Furthermore, Gilbert et al., “Dietary Protein Composition Influences Abundance of Peptide and Amino Acid Transporter Messenger Ribonucleic Acid in the Small Intestine of 2 Lines of Broiler Chicks,” Poult. Sci. 89:1663-1676 (2010), which is hereby incorporated by reference in its entirety, failed to observe this response to changes in protein composition.

The present study found up-regulation of S6 (ribosomal protein) phosphorylation and an elevated ratio of phosphor-S6/S6 in the liver of hens fed the algae diets, compared with those fed the control diet. Elevated phosphorylation of S6 promotes mRNA translation (Everaert et al., “The Effect of the Protein Level in a Pre-Starter Diet on the Post-Hatch Performance and Activation of Ribosomal Protein S6 Kinase in Muscle of Neonatal Broilers,” Br. J. Nutr. 103:206-11 (2010), which is hereby incorporated by reference in its entirety) and both algae demonstrated a unique potential in stimulating liver protein synthesis. Although this potential of algae has not been reported previously, the presumably stimulated protein synthesis was consistent with the decreased plasma 3-MH and uric acid concentrations and the greater ileal amino acid digestibility in the algae-fed hens compared with the control hens. However, the hepatic protein levels of the up-stream regulators of S6 phosphorylation including P70 and mTOR showed mixed responses to algae and protease feeding. This implies alternative mechanism of up-regulating S6 phosphorylation by algae. Duchene et al., “Tissue-Specific Regulation of S6K1 by Insulin in Chickens Divergently Selected for Growth,” Gen. Comp. Endocrinol. 156:190-198 (2008), which is hereby incorporated by reference in its entirety, reported that S6 phosphorylation did not occur through the S6K1 cascade in the liver of chickens, but most likely occurred through an alternative pathway. In addition, only the green algae+protease elevated liver content of the initiation factor eIF-4E.

In summary, these results show that the microalgal biomass can be included at much higher levels than previously thought if the hens are given a sufficient acclimation period. The need for an acclimation period may temper algae's potential in broiler, but may prove to be beneficial in laying hens and broiler breeders.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. An animal feed composition comprising:
one or more grains in an amount totaling 48-70% w/w of the composition;
a non-algal protein source in an amount totaling 15-30% w/w of the composition;
algae in an amount totaling 3-15% w/w of the composition;
an exogenous protease totaling 0.01-0.1% w/w of the composition; and
an oil heterologous to the algae in an amount totaling 0.5-15% w/w of the composition.

2. The composition of claim 1, wherein the one or more grains comprises maize, wheat, rice, sorghum, oats, potato, sweet potato, cassava, DDGS, and combinations thereof.

3. The composition of claim 1, wherein the non-algae protein source comprises soybean, fishmeal, cottonseed meal, rapeseed meal, meat meal, plasma protein, blood meal, and combinations thereof.

4. The composition of claim 1, wherein the algae comprises full-fat algae.

5. The composition of claim 4, wherein the oil heterologous to the algae is present in the composition in an amount totaling 0.5-5% w/w of the composition.

6. The composition of claim 1, wherein the algae comprises de-fatted algae.

7. The composition of claim 6, wherein the oil heterologous to the algae is present in the composition in an amount totaling 3-15% w/w of the composition.

8. The composition of claim 1, wherein the oil heterologous to the algae comprises corn oil.

9. The composition of claim 1, wherein the algae comprises the green marine algae Desmodesmus sp.

10. The composition of claim 1, further comprising one or more of the following:
an inorganic phosphate source in an amount totaling up to 1.5% w/w of the composition;
a sodium source in an amount totaling up to 0.5% w/w of the composition; and
one or more amino acids selected from the group consisting of lysine, threonine, isoleucine, tryptophan, and methionine in an amount totaling up to 0.5% w/w of the composition.

11. The composition of claim 10, wherein the phosphate source comprises dicalcium phosphate.

12. The composition of claim 1 further comprising one or more of the following:
plasma protein in an amount totaling 0.5-3.0% w/w of the composition;
an inorganic calcium source in an amount totaling 0.1-10% w/w of the composition;
a vitamin/mineral mix in an amount totaling 0.1-1% w/w of the composition, wherein the vitamin/mineral mix comprises one or more trace minerals;
an inorganic magnesium source in an amount totaling 0.01-0.1% w/w of the composition; and
an antibiotic in an amount totaling 0.01-0.1% w/w of the composition.

13. The composition of claim 12, wherein the one or more trace minerals are selected from Cu, Se, Zn, I, Mn, Fe, and Co.

14. An animal feed supplement comprising:
algae;
an exogenous protease; and
an oil heterologous to the algae.

15. The animal feed supplement of claim 14, wherein the algae comprises full-fat algae.

16. The animal feed supplement of claim 14, wherein the algae comprises de-fatted algae.

17. The animal feed supplement of claim 14, wherein the oil heterologous to the algae comprises corn oil.

18. The animal feed supplement of claim 14, wherein the algae comprises the green marine algae Desmodesmus sp.

19. The animal feed supplement of claim 14 further comprising any one or more of the following:
an inorganic phosphate source;
a sodium source; and
one or more amino acids selected from the group consisting of lysine, threonine, isoleucine, tryptophan, and methionine.

20. The animal feed supplement of claim 19, wherein the inorganic phosphate source comprises dicalcium phosphate.

21. The animal feed supplement of claim 14 further comprising one or more of the following:
plasma protein;
an inorganic calcium source;
a vitamin/mineral mix;
an inorganic magnesium source; and
an antibiotic.

22. The animal feed supplement of claim 21, wherein the one or more trace minerals are selected from Cu, Se, Zn, I, Mn, Fe, and Co.

23. A method of feeding an animal, said method comprising:
administering to an animal the animal feed composition of claim 1.

24. The method of claim 23, wherein the animal is selected from the group consisting of a ruminant, poultry, swine, aquaculture, pet, dog, cat, horse, zoo animal, mouse, rat, rabbit, guinea pig, and hamster.

25. The method of claim 23, wherein the animal is a weanling pig.

26. A method of feeding an animal, said method comprising:
administering to an animal an animal feed in combination with the animal feed supplement of claim 14.

27. The method of claim 26, wherein the animal is selected from the group consisting of a ruminant, poultry, swine, aquaculture, pet, dog, cat, horse, zoo animal, mouse, rat, rabbit, guinea pig, and hamster.

28. The method of claim 27, wherein the animal is a weanling pig.

29. A method of improving the feed efficiency of an animal, said method comprising:
administering to an animal an animal feed in combination with the animal feed supplement of claim 14 under conditions effective to cause a decrease in plasma nitrogen concentration in the animal relative to such animal receiving the animal feed without the animal feed supplement, thereby improving the feed efficiency in the animal.

30. The method of claim 29, wherein the animal is selected from the group consisting of a ruminant, poultry, swine, aquaculture, pet, dog, cat, horse, zoo animal, mouse, rat, rabbit, guinea pig, and hamster.

31. The method of claim 30, wherein the animal is a weanling pig.

32. A method of improving the feed efficiency of an animal, said method comprising:
administering to an animal the animal feed composition of claim 1 under conditions effective to cause a decrease in concentration in the animal relative to such animal receiving an animal feed other than the animal feed composition, thereby improving the feed efficiency in the animal.

33. The method of claim 32, wherein the animal is selected from the group consisting of a ruminant, poultry, swine, aquaculture, pet, dog, cat, horse, zoo animal, mouse, rat, rabbit, guinea pig, and hamster.

34. The method of claim 33, wherein the animal is a weanling pig.

35. In an animal feed, the improvement comprising:
algae and
an exogenous protease, wherein the algae and exogenous protease are in an amount effective to cause a decrease in plasma nitrogen concentration in an animal fed the animal feed.

36. The animal feed of claim 35, wherein the animal is selected from the group consisting of a ruminant, poultry, swine, aquaculture, pet, dog, cat, horse, zoo animal, mouse, rat, rabbit, guinea pig, and hamster.

37. The animal feed of claim 36, wherein the animal is a weanling pig.

38. The animal feed of claim 35, wherein the algae comprises full-fat algae.

39. The animal feed of claim 35, wherein the algae comprises de-fatted algae.

40. The animal feed of claim 35, wherein the algae comprises the green marine algae Desmodesmus sp.


SEQUENCE LISTING (10 sequences)

SEQ ID NO: 1 - DNA, 24 bp, artificial
  Apn forward primer
acctcatcctgatccacagcaaca

SEQ ID NO: 2 - DNA, 24 bp, artificial
  Apn reverse primer
tgaagatgctgaagaggcggtagt

SEQ ID NO: 3 - DNA, 20 bp, artificial
  Cat11 forward primer
ccggctctcacggtgcctca

SEQ ID NO: 4 - DNA, 20 bp, artificial
  Cat11 reverse primer
tgccacagccccagccagta

SEQ ID NO: 5 - DNA, 24 bp, artificial
  Lat1 forward primer
tacagtgtgaaagctgctacccgt

SEQ ID NO: 6 - DNA, 24 bp, artificial
  Lat1 reverse primer
cgcaacgttagacttgcttcggtt

SEQ ID NO: 7 - DNA, 24 bp, artificial
  Pept1 forward primer
agctatgcagattcagccagacca

SEQ ID NO: 8 - DNA, 24 bp, artificial
  Pept1 reverse primer
acatgccaacagtgatcctcctca

SEQ ID NO: 9 - DNA, 23 bp, artificial
  BAct forward primer
agacatcagggtgtgatggttgt

SEQ ID NO: 10 - DNA, 24 bp, artificial
  BAct reverse primer
tcccagttggtgacaataccgtgt